(19) United States
(12) Patent Application Publication
(10) Pub. No.: US 2026/0246132 A1
(43) Pub. Date: Aug. 20, 2026

(54) ANTENNA MODULE ARRANGED IN VEHICLE

(71) Applicant: LG ELECTRONICS INC., Seoul (KR)

(72) Inventors: Kangjae JUNG, Seoul (KR); Byeongyong PARK, Seoul (KR); Ilnam CHO, Seoul (KR); Byungwoon JUNG, Seoul (KR); Dongjin KIM, Seoul (KR); Kukheon CHOI, Seoul (KR); Uisheon KIM, Seoul (KR)

(73) Assignee: LG ELECTRONICS INC., Seoul (KR)

(21) Appl. No.: 18/993,970

(22) PCT Filed: Jul. 13, 2022
(86) PCT No.: PCT/KR2022/010240

§ 371 Date: Jan. 13, 2025

(51) Int. Cl. H01Q 1/12; H01Q 5/30; H01Q 13/00

(52) U.S. Cl. CPC H01Q 1/1271; H01Q 5/30; H01Q 13/00

(57) ABSTRACT

This antenna assembly includes: a dielectric substrate; a first region including conductive patterns on one side of the dielectric substrate and configured to radiate a wireless signal; and a second region including a ground conductive pattern and a feed pattern. The conductive patterns may include a first conductive pattern including a first portion and a second portion, a second conductive pattern electrically connected to a first portion of the ground conductive pattern, and a third conductive pattern electrically connected to a second portion of the ground conductive pattern. The size of the second conductive pattern may be smaller than the size of the third conductive pattern. The size of the third conductive pattern may be greater than the size of the first conductive pattern.

### TECHNICAL FIELD

The present disclosure relates to a transparent antenna arranged in a vehicle. A specific implementation relates to an antenna assembly made of a transparent material to suppress an antenna region from being visible on glass of a vehicle.

### BACKGROUND ART

A vehicle may perform wireless communication services with other vehicles, nearby objects, infrastructures, or a base station. In this regard, various communication services may be provided through a wireless communication system to which a long-term evolution (LTE) communication technology or a 5G communication technology is applied. Meanwhile, some of LTE frequency bands may be allocated to provide 5G communication services.

On the other hand, a vehicle body and a vehicle roof are formed of a metallic material, which causes a problem of blocking radio waves. Accordingly, a separate antenna structure may be disposed on top of the vehicle body or roof. Alternatively, when the antenna structure is disposed below the vehicle body or roof, a portion of the vehicle body or roof corresponding to an antenna arrangement region may be formed of a non-metallic material.

However, in terms of design, the vehicle body or roof needs to be integrally formed. In this case, the exterior of the vehicle body or roof may be made of a metallic material. This may cause antenna efficiency to be drastically lowered due to the vehicle body or roof.

In relation to this, to increase a communication capacity without a change in the exterior design of the vehicle, a transparent antenna may be disposed on glass corresponding to a window of the vehicle. However, antenna radiation efficiency and impedance bandwidth characteristics are deteriorated due to electrical loss of the transparent antenna.

When an antenna pattern is configured to have a metal mesh structure in which metal lines are connected to each other on a dielectric substrate, a transparent antenna in which the metal lines are not visually distinguishable may be implemented. However, when a metal mesh structure is not disposed in a dielectric region surrounding an antenna region having an antenna pattern therein, the antenna region is visually distinguished from the dielectric region, thus resulting in a difference in visibility.

To solve such a problem, a dummy mesh grid may be placed in the dielectric region. However, as the dummy mesh grid is placed, interference with an antenna pattern may occur, and thus, antenna performance may deteriorate.

Meanwhile, when a transparent antenna is disposed on vehicle glass, a transparent antenna pattern may be electrically connected to a feed pattern disposed on a separate dielectric substrate. In this regard, feed loss and antenna performance degradation may occur due to the connection between the transparent antenna pattern and the feed pattern. In addition, a difference in transparency may occur between a transparent region in which the transparent antenna pattern is formed and an opaque region in which the feed pattern is formed. Depending on the difference in transparency, a region in which the antenna is disposed may be visually distinguished from other regions. Despite the difference in transparency, a method for minimizing a difference in visibility between the antenna region and the other regions within the vehicle glass.

### DISCLOSURE OF INVENTION

### Technical Problem

The present disclosure is directed to solving the aforementioned problems and other drawbacks. Another aspect of the present disclosure is to provide a broadband transparent antenna assembly that may be disposed on vehicle glass.

Another aspect of the present disclosure is to improve antenna efficiency of a broadband transparent antenna assembly that may be disposed on vehicle glass.

Another aspect of the present disclosure is to provide a broadband antenna structure made of a transparent material capable of reducing feeding loss and improving antenna efficiency while operating in a wide band.

Another aspect of the present disclosure is to improve antenna efficiency of a feeding structure of a broadband transparent antenna assembly that may be disposed on vehicle glass, and secure reliability of a mechanical structure including the feeding structure.

Another aspect of the present disclosure is to minimize interference between a dummy mesh grid disposed in a dielectric region and an antenna region.

Another aspect of the present disclosure is to ensure invisibility of a transparent antenna and an antenna assembly including the same without deterioration of antenna performance.

Another aspect of the present disclosure is to ensure both invisibility of a shape of an antenna assembly and invisibility when the antenna assembly is attached to a display or glass.

Another aspect of the present disclosure is to improve visibility in a transparent antenna without deterioration of antenna performance through an optimal design of a dummy pattern having an opened region.

### Solution to Problem

To achieve these and other advantages and in accordance with the purpose of the present disclosure, as embodied and broadly described herein, there is provided an antenna assembly including: a dielectric substrate; a first region including conductive patterns on one side surface of the dielectric substrate and configured to radiate a wireless signal; and a second region including a ground conductive pattern and a feed pattern. The conductive patterns may include: a first conductive pattern including a first portion and a second portion; a second conductive pattern electrically connected to a first portion of the ground conductive pattern; and a third conductive pattern electrically connected to a second portion of the ground conductive pattern. The second conductive pattern may have a size smaller than a size of the third conductive pattern. The third conductive pattern may have a size greater than a size of the first conductive pattern.

As an embodiment, the first portion of the first conductive pattern may be perpendicular to the second portion, and the second portion may be electrically connected to the feed pattern. The second conductive pattern may be located between the first portion of the first conductive pattern and the second portion of the first conductive pattern. The first portion of the first conductive pattern is located at a side opposite to the third conductive pattern with reference to the second portion of the first conductive pattern.

According to another aspect of the present disclosure, there is also provided an antenna assembly including: a first dielectric substrate; a first region including conductive patterns on one side surface of the first dielectric substrate and configured to radiate a wireless signal; a second dielectric substrate; and a second region including a ground conductive pattern and a feed pattern each on one side surface of the second dielectric substrate. The conductive patterns may include: a first conductive pattern including a first portion and a second portion; a second conductive pattern electrically connected to a first portion of the ground conductive pattern; and a third conductive pattern electrically connected to a second portion of the ground conductive pattern. The second conductive pattern may have a size smaller than a size of the third conductive pattern. The third conductive pattern may have a size greater than a size of the first conductive pattern.

As an embodiment, the first portion of the first conductive pattern may be perpendicular to the second portion and the second portion may be electrically connected to the feed pattern. The second conductive pattern may be located between the first portion of the first conductive pattern and the second portion of the first conductive pattern. The first portion of the first conductive pattern may be located at a side opposite to the third conductive pattern with reference to the second portion of the first conductive pattern.

Hereinafter, configurations of embodiments related to the antenna assembly according to an aspect of the present disclosure and the antenna assembly according to another aspect of the present disclosure are described. As an embodiment, the first conductive pattern and the third conductive pattern may operate in a dipole antenna mode in a first frequency band. The first conductive pattern and the third conductive pattern may be configured have an asymmetrical structure.

As an embodiment, the first conductive pattern may operate in a monopole antenna mode in a second frequency band. The second frequency band may be larger than the first frequency band.

As an embodiment, the second conductive pattern may operate in a third frequency band. The third frequency band may be larger than the second frequency band.

As an embodiment, a first boundary side of the first portion of the first conductive pattern may have a first step structure. A second boundary side of the first portion of the first conductive pattern may have a second step structure, and the second step structure may have a shape different from a shape of the first step structure. A third boundary side of the first portion of the first conductive pattern may be disposed between a first end portion of the first boundary side of the first portion of the first conductive pattern and a first end portion of the second boundary side of the first portion of the first conductive pattern. A fourth boundary side of the first portion of the first conductive pattern may be disposed between a second end portion of the first boundary side of the first portion of the first conductive pattern and a second end portion of the second boundary side of the first portion of the first conductive pattern.

As an embodiment, a part of the first boundary side of the first portion of the first conductive pattern may be disposed to face a first boundary side of the second conductive pattern. A part of the first boundary side of the second conductive pattern may be disposed to face a second boundary side of the second conductive pattern.

As an embodiment, a first boundary side of the third conductive pattern may have a third step structure. A first end portion of the first boundary side of the third conductive pattern may be connected to the second portion of the ground conductive pattern. A second boundary side of the third conductive pattern may be disposed at a side opposite to the first boundary side of the third conductive pattern. A third boundary side of the third conductive pattern may be disposed between the first end portion of the first boundary side of the third conductive pattern and a first end portion of the second boundary side of the third conductive pattern. A fourth boundary side of a fourth conductive pattern may be disposed between a second end portion of the first boundary side of the third conductive pattern and a second end portion of the second boundary side of the third conductive pattern.

As an embodiment, the third boundary side of the third conductive pattern may be disposed at a side opposite to the fourth boundary side of the fourth conductive patter. A part of the second portion of the first conductive pattern may be disposed face a fourth boundary side of the third conductive pattern.

As an embodiment, a length of the third boundary side of the third conductive pattern may be identical to a length of the third boundary side of the first conductive pattern.

As an embodiment, the first portion of the second region may include a first slot. A length of the first slot may be in a range from 2/2 to 2. An opened region of the first slot may be disposed to face the feed pattern.

As an embodiment, the second portion of the second region may include a second slot. A length of the second slot may be in a range from 2/2 to 2. An opened region of the second slot may be disposed to face the first region.

As an embodiment, the first conductive pattern, the second conductive pattern, and the third conductive pattern may be configured to have a metal mesh shape having a plurality of opened regions on the dielectric substrate. The first conductive pattern, the second conductive pattern, and the third conductive pattern may have a coplanar waveguide (CPW) structure on the dielectric substrate.

As an embodiment, the antenna assembly may include a plurality of dummy mesh grid patterns on an outside portion of the first region on the dielectric substrate. The plurality of dummy metal grid patterns may be configured not to be connected to the feed pattern and the ground conductive pattern. The plurality of dummy mesh grid patterns may be configured to be separate from each other.

### Advantageous Effects of Invention

Hereinafter, technical effects of a broadband transparent antenna assembly capable of being disposed on vehicle glass are described.

According to the present disclosure, a wideband transparent antenna assembly capable of being disposed on vehicle glass and having a plurality of conductive patterns may be provided to allow 4G/5G wideband wireless communication in a vehicle.

According to the present disclosure, shapes of conductive patterns may be optimized in a wideband transparent antenna assembly capable of being disposed on vehicle glass, and antenna efficiency may be enhanced through an asymmetrical conductive pattern structure.

According to the present disclosure, an end portion of a conductive pattern of a transparent dielectric substrate may be connected to an end portion of a conductive pattern of an opaque substrate to overlap each other to be capable of reducing a feeding loss.

According to the present disclosure, a wideband antenna structure made of a transparent material and capable of enhancing antenna efficiency may be implemented by setting an antenna operation mode differently according to respective frequency bands while reducing a feeding loss.

According to the present disclosure, efficiency of a feeding structure of a wideband transparent antenna assembly may be enhanced by coupling a feed pattern of a feeding structure implemented as an opaque substrate disposed in an opaque region of vehicle glass directly to a transparent antenna.

According to the present disclosure, reliability of a mechanical structure including a feeding structure may be ensured through low-temperature bonding of a feed pattern of the feeding structure to a conductive pattern of an antenna module.

According to the present disclosure, an open dummy region in which slits are disposed in a dielectric region may be configured to minimize a difference in visibility between a region in which an antenna having a transparent material is disposed and other regions.

According to the present disclosure, as a boundary of an antenna region is apart from a boundary of a dummy pattern region by a predetermined space, invisibility of a transparent antenna and an antenna assembly including the transparent antenna may be ensured without deterioration of antenna performance.

According to the present disclosure, an open dummy structure may be configured such that intersections of metal lines in a dummy region or respective one points of the metal lines are disconnected to thereby ensure invisibility of a transparent antenna and an antenna assembly including the transparent antenna without deterioration of antenna performance.

According to the present disclosure, visibility may be enhanced in a transparent antenna without deterioration of antenna performance through an optimal design of slits in a dummy pattern having an opened region and via an opened region toward a radiator region.

According to the present disclosure, a broadband antenna structure made of a transparent material and capable of reducing a feeding loss and enhancing antenna efficiency while operating in a wide band may be provided through vehicle glass or a display area of an electronic device.

According to the present disclosure, a transparent antenna structure capable of performing wireless communication in 4G and 5G frequency bands may be provided while minimizing a change in antenna performance and a difference in transparency between an antenna region and a peripheral region.

Further scope of applicability of the disclosure will become apparent from the following detailed description. It should be understood, however, that the detailed description and specific examples, such as the preferred embodiments, are given by way of illustration only, since various changes and modifications within the spirit and scope of the disclosure will be apparent to those skilled in the art.

### BRIEF DESCRIPTION OF DRAWINGS

FIG. 1 is a diagram illustrating glass of a vehicle in which an antenna structure according to an embodiment of the disclosure may be disposed.

FIG. 2A is a front view of the vehicle with an antenna assembly disposed in different regions of a front glass of the vehicle of FIG. 1.

FIG. 2B is a front perspective view illustrating the inside of the vehicle with the antenna assembly disposed in the different regions of the front glass of the vehicle of FIG. 1.

FIG. 2C is a side perspective view of the vehicle with the antenna assembly disposed on upper glass of the vehicle of FIG. 1.

FIG. 3 illustrates types of V2X applications.

FIG. 4 is a block diagram referenced for explaining a vehicle and an antenna system mounted on the vehicle according to an embodiment of the disclosure.

FIGS. 5A to 5C illustrate a configuration that an antenna assembly according to the disclosure is disposed on vehicle glass.

FIG. 6A illustrates various embodiments of a frit pattern according to the disclosure. FIGS. 6B and 6C are diagrams illustrating a transparent antenna pattern and a structure in which the transparent antenna pattern is disposed on vehicle glass according to embodiments.

FIG. 7A shows a front view and a cross-sectional view of a transparent antenna assembly according to the disclosure. FIG. 7B is a diagram illustrating a grid structure of a metal mesh radiator region and a dummy metal mesh region according to embodiments.

FIG. 8A illustrates a layered structure of an antenna module and a feeding module. FIG. 8B illustrates an opaque substrate including the layered structure, in which the antenna module and the feeding structure are coupled to each other, and a coupled portion.

FIG. 9A is a diagram illustrating a coupling structure of a transparent antenna that is disposed in a transparent region and a frit region of vehicle glass.

FIG. 9B is an enlarged front view of a region where glass with the transparent antenna of FIG. 9A is coupled to a body structure of the vehicle. FIG. 9C is a cross-sectional view illustrating the coupling structure between the vehicle glass and the body structure of FIG. 9B, viewed from different positions.

FIG. 10 is a diagram illustrating a stacked structure of an antenna assembly and an attachment region between vehicle glass and a vehicle frame according to embodiments.

FIGS. 11A and 11B are front views of the antenna assembly according to embodiments of the present disclosure.

FIG. 12A shows comparison between a radiation pattern of a monopole antenna operating in a single band and a radiation pattern of the antenna assembly according to the present disclosure.

FIG. 12B shows comparison between gain characteristics of the monopole antenna of FIG. 12A and gain characteristics of the antenna assembly according to the present disclosure.

FIGS. 13A to 13C are conceptual diagrams illustrating an operating principle of the antenna assembly 1000 of FIG. 11B in each frequency band.

FIGS. 14A and 14B illustrate structures in which a shape of a second conductive pattern and a shape of a third conductive pattern are changed.

FIG. 14C illustrates a structure in which shapes of first and third conductive patterns are disposed in a continuous structure.

FIG. 15A shows comparison between reflection coefficient characteristics of the antenna assemblies of FIGS. 11A and 14C. FIG. 15B shows comparison between antenna efficiency characteristics of the antenna assemblies of FIGS. 11A and 14C.

FIG. 16A antenna efficiencies of antenna assemblies having an asymmetrical structure and a symmetrical structure shown in FIG. 11B and FIG. 14B, respectively. FIG. 16B shows electric field distributions of the antenna assemblies having the asymmetrical structure and the symmetrical structure shown in FIG. 11B and FIG. 14B, respectively.

FIG. 17A illustrates first and second slot structures disposed in a ground conductive pattern of the antenna assembly according to the present disclosure.

FIG. 17B illustrates current distribution in the first and second slot structures disposed in the ground conductive pattern of the antenna assembly of FIG. 17A and in a periphery of the ground conductive pattern.

FIG. 17C illustrates a circular slot structure of the antenna assembly according to an embodiment.

FIGS. 18A to 18C are views illustrating electric field distributions defined on conductive patterns of the antenna assembly in first to third frequency bands.

FIG. 19 shows reflection coefficient characteristics according to presence or absence of a slot for impedance matching in a coplanar waveguide (CPW) antenna structure according to the present disclosure

FIG. 20 illustrates a structure in which first and second dielectric substrates of the antenna assembly according to an embodiment are combined.

FIGS. 21A and 21B illustrate a flow of processes in which the antenna assembly according to embodiments is manufactured by being coupled to a glass panel.

FIG. 22 illustrates an example of a configuration in which a plurality of antenna modules disposed at different positions in a vehicle according to the present disclosure are coupled to other components of the vehicle.

### MODE FOR THE INVENTION

A description will now be given in detail according to exemplary embodiments disclosed herein, with reference to the accompanying drawings. For the sake of brief description with reference to the drawings, the same or equivalent components may be provided with the same or similar reference numbers, and description thereof will not be repeated. A suffix “module” or “unit” used for elements disclosed in the following description is merely intended for easy description of the specification, and the suffix itself is not intended to give any special meaning or function. In describing the embodiments disclosed herein, moreover, the detailed description will be omitted when specific description for publicly known technologies to which the invention pertains is judged to obscure the gist of the disclosure. The accompanying drawings are used to help easily understand various technical features and it should be understood that the embodiments presented herein are not limited by the accompanying drawings. As such, the disclosure should be construed to extend to any alterations, equivalents and substitutes in addition to those which are particularly set out in the accompanying drawings. The idea of the present disclosure should be construed to extend to any alterations, equivalents and substitutes besides the accompanying drawings.

It will be understood that although the terms first, second, etc. may be used herein to describe various elements, these elements should not be limited by these terms. These terms are generally only used to distinguish one element from another.

It will be understood that when an element is referred to as being “connected with” another element, the element may be connected with the another element or intervening elements may also be present. In contrast, when an element is referred to as being “directly connected with” another element, there are no intervening elements present.

A singular representation may include a plural representation unless it represents a definitely different meaning from the context.

Terms “include” or “has” used herein should be understood that they are intended to indicate the existence of a feature, a number, a step, an element, a component or a combination thereof disclosed in the specification, and it may also be understood that the existence or additional possibility of one or more other features, numbers, steps, elements, components or combinations thereof are not excluded in advance.

An antenna system described herein may be mounted on a vehicle. Configurations and operations according to embodiments may also be applied to a communication system, namely, an antenna system mounted on the vehicle. In this regard, the antenna system mounted on the vehicle may include a plurality of antennas, and a transceiver circuit and a processor both configured to control the plurality of antennas.

Hereinafter, a description will be given of an antenna assembly (antenna module) that may be disposed on a window of a vehicle according to the disclosure, and an antenna system for a vehicle that includes the antenna assembly. In relation to this, the antenna assembly may refer to a structure in which conductive patterns are combined on a dielectric substrate, and may also be referred to as an antenna module.

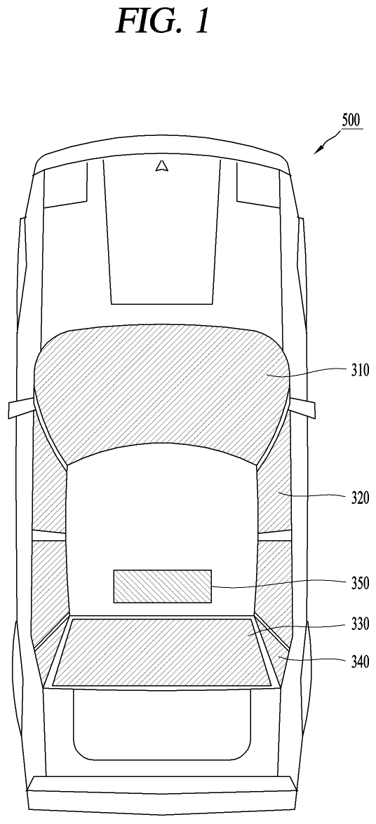

In relation to this, FIG. 1 illustrates glass of a vehicle on which an antenna module according to an embodiment may be arranged. Referring to FIG. 1, the vehicle 500 may include front glass 310, door glass 320, rear glass 330, and quarter glass 340. In some examples, the vehicle 500 may further include top glass 350 disposed on a roof in an upper region.

Therefore, the glass constituting a window of the vehicle 500 may include the front glass 310 disposed in a front region of the vehicle, the door glass 320 disposed in a door region of the vehicle, and the rear glass 330 disposed in a rear region of the vehicle. In some examples, the glass constituting the window of the vehicle 500 may further include the quarter class 340 disposed in a partial region of the door region of the vehicle. In addition, the glass constituting the window of the vehicle 500 may further include the top glass 350 spaced apart from the rear glass 330 and disposed in an upper region of the vehicle. Accordingly, each glass constituting the window of the vehicle 500 may be referred to as a window.

The front glass 310 may be referred to as a front windshield because it suppresses wind blown from a front side from entering the inside of the vehicle. The front glass 310 may have a two-layer bonding structure having a thickness of about 5.0 to 5.5 mm. The front glass 310 may have a bonding structure of glass/shatterproof film/glass.

The door glass 320 may have a two-layer bonding structure or may be made of single-layer compressed glass. The rear glass 330 may have a two-layer bonding structure having a thickness of about 3.5 to 5.5 mm or may be made of single-layer compressed glass. In the rear glass 330, a spaced distance is required between a transparent antenna and a hot wire and AM/FM antenna. The quarter glass 340 may be made of single-layer compressed glass having a thickness of about 3.5 to 4.0 mm, but is not limited thereto.

A size of the quarter glass 340 may vary depending on a type of the vehicle. The quarter glass 340 may have a size smaller than sizes of the front glass 310 and the rear glass 330.

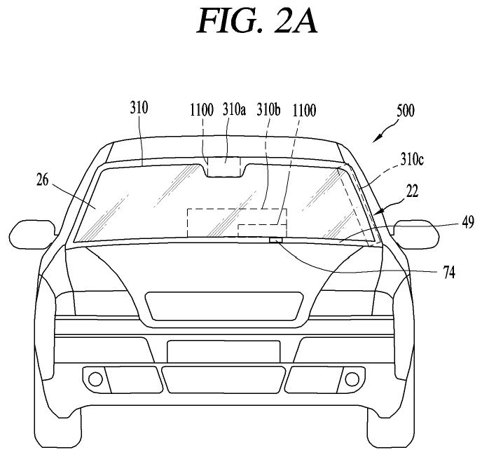

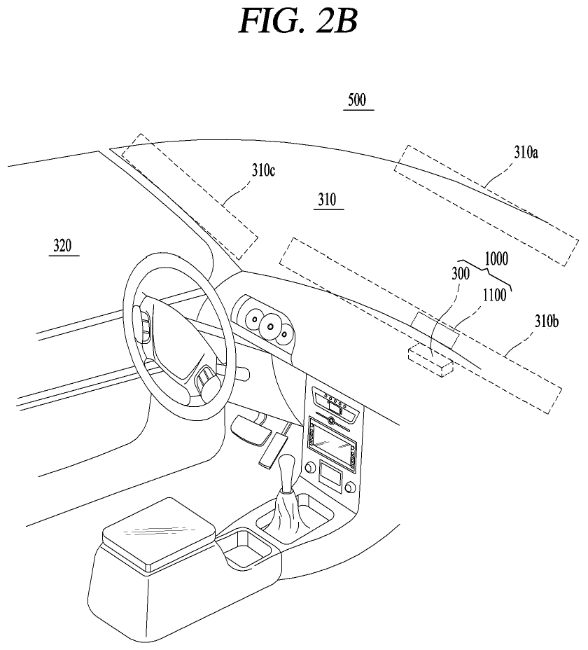

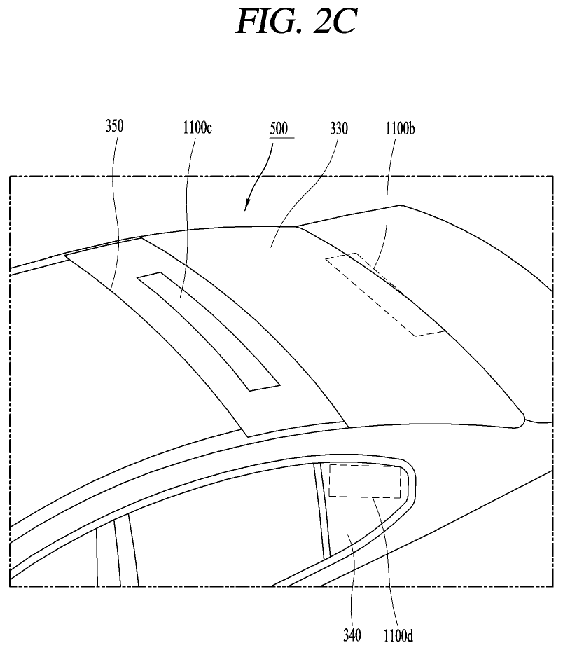

Hereinafter, a structure in which an antenna assembly according to the present disclosure is disposed in different regions of the front glass of a vehicle will be described. An antenna assembly attached to the vehicle glass may be implemented as a transparent antenna. In this regard, FIG. 2A is a front view of the vehicle with an antenna assembly disposed in different regions of the front glass of the vehicle of FIG. 1. FIG. 2B is a front perspective view illustrating the inside of the vehicle with the antenna assembly disposed in the different regions of the front glass of the vehicle of FIG. 1. FIG. 2C is a side perspective view of the vehicle with the antenna assembly disposed on the upper glass of the vehicle of FIG. 1.

Referring to FIG. 2A which is the front view of the vehicle 500, a configuration in which the transparent antenna for the vehicle may be disposed is illustrated. A pane assembly 22 may include an antenna disposed in an upper region 310a. The pane assembly 22 may include an antenna in the upper region 310a, an antenna in a lower region 310b, and/or an antenna in a side region 310c. In addition, the pane assembly 22 may include translucent pane glass 26 configured as a dielectric substrate. The antenna in the upper region 310a, the antenna in the lower region 310b, and/or the antenna in the side region 310c may be configured to support any one or more of various communication systems.

An antenna module 1100 may be disposed in the upper region 310a, the lower region 310b, or the side region 310c of a front glass 310. When the antenna module 1100 is arranged in the lower region 310b of the front glass 310, the antenna module 1100 may extend to a body 49 of a lower region of the translucent pane glass 26. The body 49 of the lower region of the translucent pane glass 26 may have lower transparency than other portions. A portion of a feeder and other interface lines may be arranged on the body 49 of the lower region of the translucent pane glass 26. A connector assembly 74 may be implemented on the body 49 of the lower region of the translucent pane glass 26. The body 49 of the lower region may constitute a vehicle body made of a metal material.

Referring to FIG. 2B, an antenna assembly 1000 may include a telematics control unit (TCU) 300 and an antenna module 1100. The antenna module 1100 may be located in a different region of glass of the vehicle.

Referring to FIGS. 2A and 2B, the antenna assembly may be disposed in the upper region 310a, the lower region 310b, and/or the side region 310c of the vehicle glass. Referring to FIGS. 2A to 2C, the antenna assembly may be disposed in the front glass 310, rear glass 330, quarter glass 340, and upper glass 350 of the vehicle.

Referring to FIGS. 2A to 2C, the antenna arranged in the upper region 310a of the front glass 310 of the vehicle may be configured to operate in a low band (LB), a mid band (MB), a high band (HB), and a 5G Sub6 band of 4G/5G communication systems. The antenna in the lower region 310b and/or the antenna in the side region 310c may also be configured to operate in the LB, MB, HB, and 5G Sub6 band of the 4G/5G communication systems. An antenna structure 1100b on the rear glass 330 of the vehicle may also be configured to operate in the LB, MB, HB, and 5G Sub6 band of the 4G/5G communication systems. An antenna structure 1100c on the upper glass 350 of the vehicle may also be configured to operate in the LB, MB, HB, and 5G Sub6 band of the 4G/5G communication systems. An antenna structure 1100d on the quarter glass 350 of the vehicle may also be configured to operate in the LB, MB, HB, and 5G Sub6 band of the 4G/5G communication systems.

At least a portion of an outer region of the front glass 310 of the vehicle may be defined by the translucent pane glass 26. The translucent pane glass 26 may include a first portion in which an antenna and a portion of a feeder are disposed, and a second portion in which another portion of the feeder and a dummy structure are disposed. The translucent pane 26 may further include a dummy region in which conductive patterns are not formed. For example, a transparent region of the translucent pane 22 may be transparent to secure light transmission and a field of view.

Although it is exemplarily illustrated that conductive patterns may be formed in a partial region of the front glass 310, the conductive patterns may extend to the side glass 320 and the rear glass 330 of FIG. 1, and an arbitrary glass structure. In the vehicle 500, the occupants or driver may view road and surrounding environment through the pane assembly 22. In addition, the occupants or driver may view the road and surrounding environment without interference with the antenna in the upper region 310a, the antenna in the lower region 310b, and/or the antenna in the side region 310c.

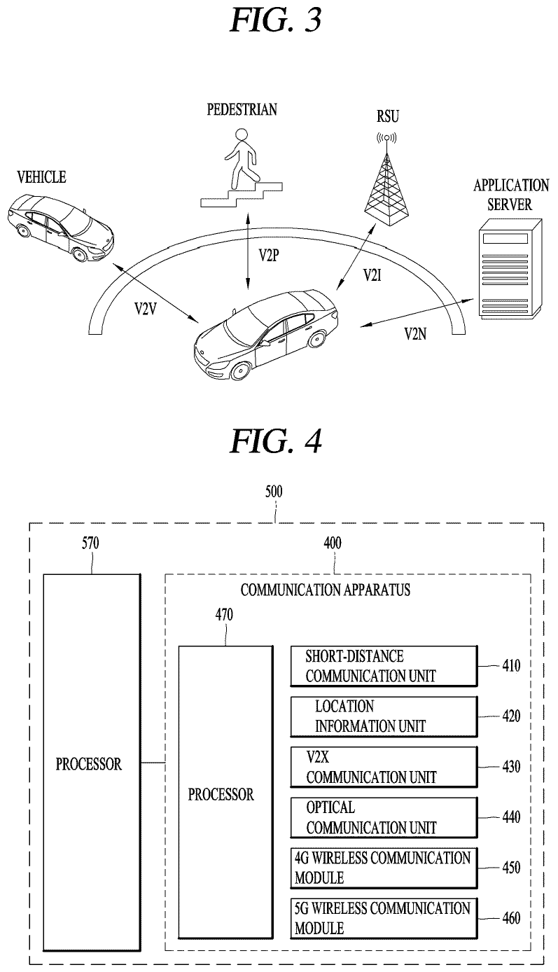

The vehicle 500 may be configured to communicate with pedestrians, surrounding infrastructures, and/or servers in addition to adjacent vehicles. In relation to this, FIG. 3 illustrates types of V2X applications. Referring to FIG. 3, vehicle-to-everything (V2X) communication may include communication between a vehicle and each of all entities, such as vehicle-to-vehicle (V2V) communication which refers to communication between vehicles, vehicle-to-Infrastructure (V2I) communication which refers to communication between a vehicle and an eNB or a road side unit (RSU), vehicle-to-pedestrian (V2P) communication which refers to communication between a vehicle and a terminal carried by a person (a pedestrian, a cyclist, a vehicle driver, or a passenger), vehicle-to-network (V2N) communication, and the like.

Meanwhile, FIG. 4 is a block diagram illustrating a vehicle and an antenna system mounted on the vehicle in accordance with an embodiment.

The vehicle 500 may include the communication device 400 and a processor 570. The communication device 400 may correspond to a telematics control unit of the vehicle 500.

The communication device 400 may be a device for performing communication with an external device. Here, the external device may be another vehicle, a mobile terminal, or a server. The communication device 400 may perform the communication by including at least one of a transmitting antenna, a receiving antenna, and radio frequency (RF) circuit, and an RF device for implementing various communication protocols. In this regard, the communication device 400 may include a short-range communication unit 410, a location information unit 420, a V2X communication unit 430, an optical communication unit 440, a 4G wireless communication module 450, and a 5G wireless communication module 460. The communication device 400 may include a processor 470. According to an embodiment, the communication device 400 may further include other components in addition to the components described, or may not include some of the components described.

A 4G wireless communication module 450 and a 5G wireless communication module 460 perform wireless communication with one or more communication systems through one or more antenna modules. The 4G wireless communication module 450 may transmit and/or receive signals to and/or from a device in a first communication system through a first antenna module. In addition, the 5G wireless communication module 460 may transmit and/or receive signals to and/or from a device in a second communication system through a second antenna module. The 4G wireless communication module 450 and 5G wireless communication module 460 may be physically implemented as one integrated communication module. For example, the first communication system and the second communication system may be an LTE communication system and a 5G communication system, respectively. However, the first communication system and the second communication system may not be limited thereto, and may be changed according to applications.

The processor of the device in the vehicle 500 may be implemented as a micro control unit (MCU) or a modem. The processor 470 of the communication device 400 may correspond to a modem, and the processor 470 may be implemented as an integrated modem. The processor 470 may obtain surrounding information from other adjacent vehicles, objects, or infrastructures through wireless communication. The processor 470 may perform vehicle control using the acquired surrounding information.

The processor 570 of the vehicle 500 may be a processor of a car area network (CAN) or advanced driving assistance system (ADAS), but is not limited thereto. When the vehicle 500 is implemented in a distributed control manner, the processor 570 of the vehicle 500 may be replaced with a processor of each device.

In some examples, the antenna module disposed in the vehicle 500 may include a wireless communication unit. The 4G wireless communication module 450 may perform transmission and reception of 4G signals with a 4G base station through a 4G mobile communication network. In this case, the 4G wireless communication module 450 may transmit at least one 4G transmission signal to the 4G base station. In addition, the 4G wireless communication module 450 may receive at least one 4G reception signal from the 4G base station. In this regard, uplink (UL) multi-input and multi-output (MIMO) may be performed by a plurality of 4G transmission signals transmitted to the 4G base station. In addition, downlink (DL) MIMO may be performed by a plurality of 4G reception signals received from the 4G base station.

The 5G wireless communication module 460 may perform transmission and reception of 5G signals with a 5G base station through a 5G mobile communication network. Here, the 4G base station and the 5G base station may have a non-stand-alone (NSA) architecture. The 4G base station and the 5G base station may be disposed in the non-stand-alone (NSA) architecture. Alternatively, the 5G base station may be disposed in a stand-alone (SA) architecture at a separate location from the 4G base station. The 5G wireless communication module 460 may perform transmission and reception of 5G signals with a 5G base station through a 5G mobile communication network. In this case, the 5G wireless communication module 460 may transmit at least one 5G transmission signal to the 5G base station. In addition, the 5G wireless communication module 460 may receive at least one 5G reception signal from the 5G base station. In this instance, a 5G frequency band that is the same as a 4G frequency band may be used, and this may be referred to as LTE re-farming. In some examples, a Sub6 frequency band, which is a range of 6 GHz or less, may be used as the 5G frequency band. In contrast, a millimeter-wave (mm Wave) band may be used as the 5G frequency band to perform wideband high-speed communication. When the mm Wave band is used, the electronic device may perform beamforming for coverage expansion of an area where communication with a base station is possible.

Regardless of the 5G frequency band, in the 5G communication system, Multi-Input and Multi-Output (MIMO) may be supported to be performed multiple times, in order to improve a transmission rate. In relation to this, UL MIMO may be performed according to a plurality of 5G transmission signals that are transmitted to a 5G base station. In addition, DL MIMO may be performed by a plurality of 5G reception signals that are received from the 5G base station.

In some examples, a state of dual connectivity (DC) to both the 4G base station and the 5G base station may be attained through the 4G wireless communication module 450 and the 5G wireless communication module 460. As such, the dual connectivity with the 4G base station and the 5G base station may be referred to as EUTRAN NR DC (EN-DC). On the other hand, when the 4G base station and 5G base station are disposed in a co-located structure, throughput improvement may be achieved by inter-Carrier Aggregation (inter-CA). Accordingly, when the 4G base station and the 5G base station are disposed in the EN-DC state, the 4G reception signal and the 5G reception signal may be simultaneously received through the 4G wireless communication module 450 and the 5G wireless communication module 460, respectively. Short-range communication between electronic devices (e.g., vehicles) may be performed using the 4G wireless communication module 450 and the 5G wireless communication module 460. In one embodiment, after resources are allocated, vehicles may perform wireless communication in a V2V manner without a base station.

Meanwhile, for transmission rate improvement and communication system convergence, carrier aggregation (CA) may be carried out using at least one of the 4G wireless communication module 450 and the 5G wireless communication module 460 and a WiFi communication module 113. In this regard, 4G+WiFi carrier aggregation (CA) may be performed using the 4G wireless communication module 450 and the Wi-Fi communication module 113. Or, 5G+WiFi CA may be performed using the 5G wireless communication module 460 and the Wi-Fi communication module.

In some examples, the communication device 400 may implement a display apparatus for a vehicle together with the user interface apparatus. In this instance, the display apparatus for the vehicle may be referred to as a telematics apparatus or an Audio Video Navigation (AVN) apparatus.

In some examples, a wideband transparent antenna structure that may be disposed on glass of a vehicle may be implemented as a single dielectric substrate on the same plane as a coplanar waveguide (CPW) feeder. In addition, the wideband transparent antenna structure that may be disposed on the glass of the vehicle may be implemented as a structure in which grounds are disposed at both sides of a radiator so as to constitute a wideband structure.

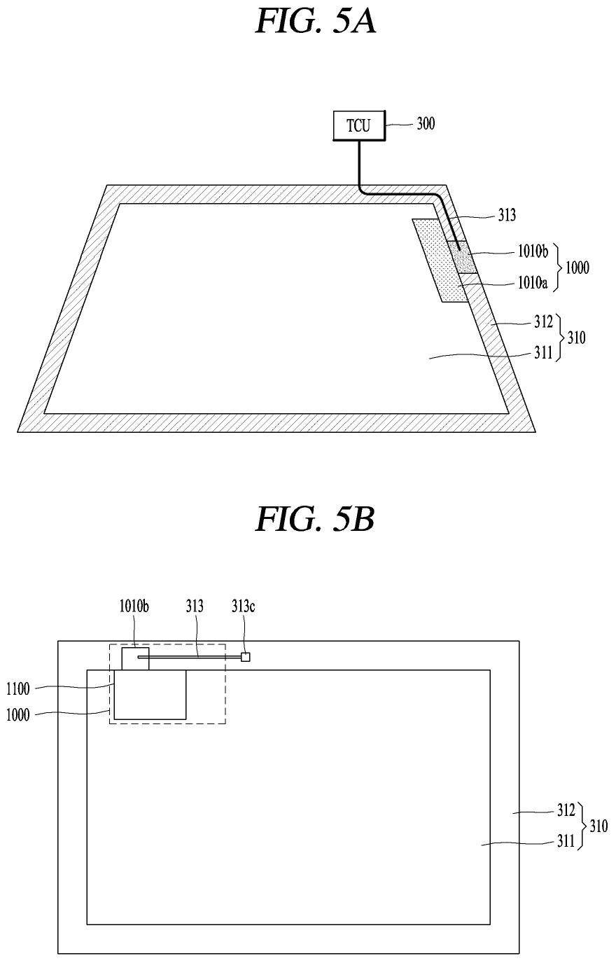

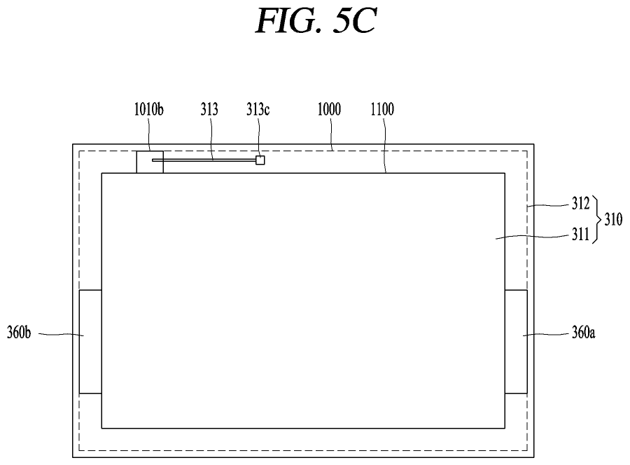

Hereinafter, an antenna assembly associated with a broadband transparent antenna structure according to the present disclosure will be described. In this regard, FIGS. 5A and 5B illustrate a configuration that the antenna assembly according to the present disclosure is disposed on the vehicle glass. Referring to FIG. 5A, the antenna assembly 1000 may include a first dielectric substrate 1010a and a second dielectric substrate 1010b. The first dielectric substrate 1010a is implemented as a transparent substrate and thus may be referred to as a transparent substrate 1010a. The second dielectric substrate 1010b may be implemented as an opaque substrate 1010b.

The glass panel 310 may be configured to include a transparent region 311 and an opaque region 312. The opaque region 312 of the glass panel 310 may be a frit region configured as a frit layer. The opaque region 312 may be disposed to surround the transparent region 311. The opaque region 312 may be disposed outside the transparent region 311. The opaque region 312 may form a boundary region of the glass panel 310.

A signal pattern disposed on the dielectric substrate 1010 may be connected to the telematics control unit (TCU) 300 through a connector part 313 such as a coaxial cable. The telematics control unit (TCU) 300 may be disposed inside the vehicle, but is not limited thereto. The telematics control unit (TCU) 300 may be disposed on a dashboard inside the vehicle or a ceiling region inside the vehicle, but is not limited thereto.

FIG. 5B illustrates a configuration in which the antenna assembly 1000 is disposed in a partial region of the glass panel 310. FIG. 5C illustrates a configuration in which the antenna assembly 1000 is disposed in an entire region of the glass panel 310.

Referring to FIGS. 5B and 5C, the glass panel 310 may include the transparent region 311 and the opaque region 312. The opaque region 312 is a non-visible region with transparency below a certain level and may be referred to as a frit region, black printing (BP) region, or black matrix (BM) region. The opaque region 312 corresponding to the non-visible region may be disposed to surround the transparent region 311. The opaque region 312 may be disposed in a region outside the transparent region 311. The opaque region 312 may form a boundary region of the glass panel 310. A second dielectric substrate 1010b or heating pads 360a and 360b corresponding to a feeding substrate may be disposed in the opaque region 312. A second dielectric substrate 1010b disposed in the opaque region 312 may be referred to as an opaque substrate. Even when the antenna assembly 1000 is disposed in the entire region of the glass panel 310 as illustrated in FIG. 5C, the heating pads 360a and 360b may be disposed in the opaque region 312.

Referring to FIG. 5B, the antenna assembly 1000 may include the first transparent dielectric substrate 1010a and the second dielectric substrate 1010b. Referring to FIGS. 5B and 5C, the antenna assembly 1000 may include the antenna module 1100 configured as conductive patterns and the second dielectric substrate 1010b. The antenna module 1100 may be configured as a transparent electrode part to be implemented as a transparent antenna module. The antenna module 1100 may be implemented as one or more antenna elements. The antenna module 1100 may include a MIMO antenna and/or other antenna elements for wireless communication. The other antenna elements may include at least one of GNSS/radio/broadcasting/WiFi/satellite communication/UWB, and remote keyless entry (RKE) antennas for vehicle applications.

Referring to FIGS. 5A to 5C, the antenna assembly 1000 may be interfaced with the telematics control unit (TCU) 300 through the connector part 313. The connector part 313 may have a connector 313c on an end portion of a cable to be electrically connected to the TCU 300. A signal pattern disposed on the second dielectric substrate 1010b of the antenna assembly 1000 may be connected to the TCU 300 through the connector part 313 such as a coaxial cable. The antenna module 1100 may be electrically connected to the TCU 300 through the connector part 313. The TCU 300 may be disposed inside a vehicle, but is not limited thereto. The TCU 300 may be disposed on a dashboard inside the vehicle or a ceiling region inside the vehicle, but is not limited thereto.

Meanwhile, when the transparent antenna assembly according to the present disclosure is attached to the inside or surface of the glass panel 310, a transparent electrode part including an antenna pattern and a dummy pattern may be disposed in the transparent region 311. On the other hand, an opaque substrate part may be disposed in the opaque region 312.

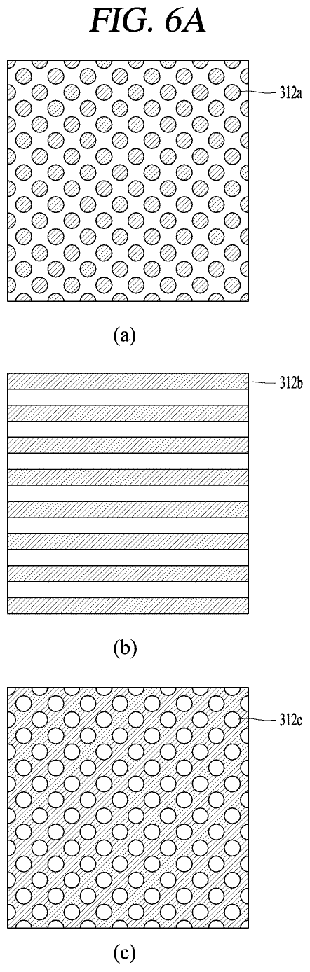

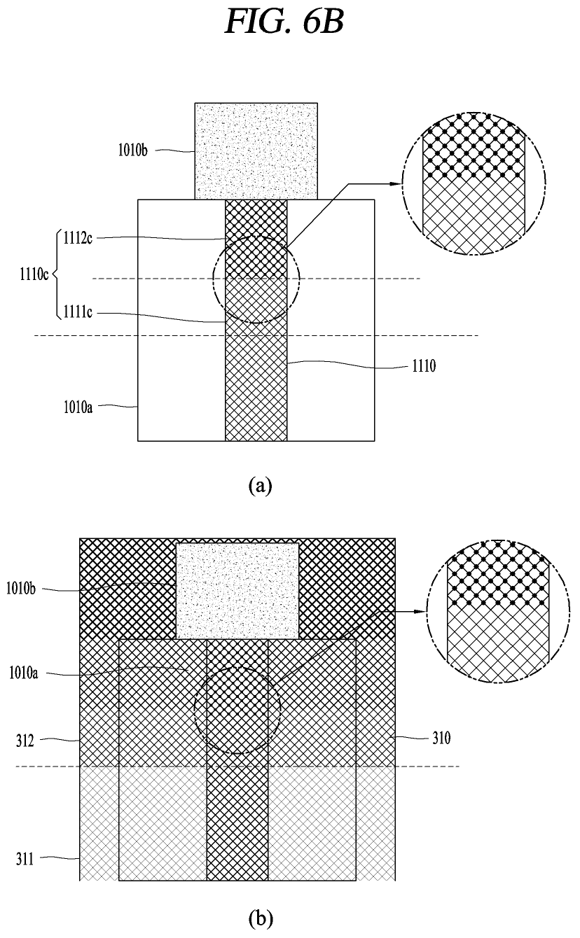

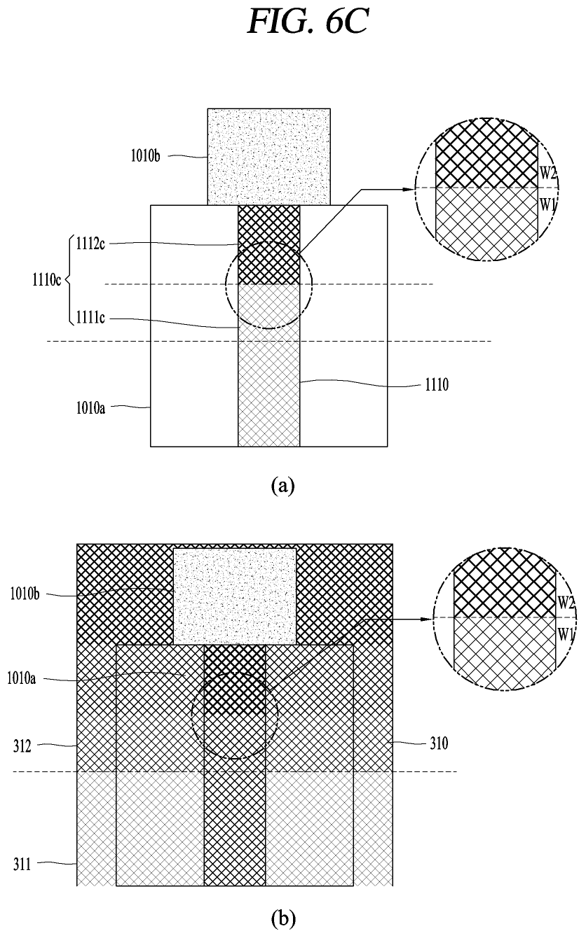

The antenna assembly disposed on the vehicle glass according to the present disclosure may be disposed in the transparent region and the opaque region. In this regard, FIG. 6A illustrates various embodiments of a frit pattern according to the present disclosure. FIGS. 6B and 6C are diagrams illustrating a transparent antenna pattern and a structure in which the transparent antenna pattern is disposed on vehicle glass according to embodiments.

Referring to (a) of FIG. 6A, the frit pattern 312A may be configured as a metal pattern in a circular (polygonal, or oval) shape with a certain diameter. The frit pattern 312A may be disposed in a two-dimensional (2D) structure in both axial directions. The frit pattern 312A may be configured in an offset structure where center points between patterns forming adjacent rows are spaced apart by a certain distance.

Referring to (b) of FIG. 6A, the frit pattern 312B may be configured as a rectangular pattern in one axial direction. The frit pattern 312c may be disposed in a one-dimensional structure in one axial direction or in a two-dimensional structure in both axial directions.

Referring to (c) of FIG. 6A, the frit pattern 312c may be configured as a slot pattern, from which a metal pattern has been removed, in a circular (polygonal or oval) shape with a certain diameter. The frit pattern 312B may be disposed in a two-dimensional (2D) structure in both axial directions. The frit pattern 312c may be configured to have an offset structure where center points between patterns forming adjacent rows are spaced apart by a certain distance.

Referring to FIGS. 5A to 6C, the opaque substrate 1010b and the transparent substrate 1010a may be electrically connected on the opaque region 312. In this regard, a dummy pattern, which is electrically very small to be a certain size or less, may be disposed adjacent to the antenna pattern to secure non-visibility of a transparent antenna pattern. Accordingly, the pattern within the transparent electrode may be made invisible to the naked eye without deterioration of antenna performance. The dummy pattern may be designed to have light transmittance similar to that of the antenna pattern within a certain range.

The transparent antenna assembly including the opaque substrate 1010b bonded to the transparent electrode part may be mounted on the glass panel 310. In this regard, to ensure invisibility, the opaque substrate 1010b connected to an RF connector or coaxial cable is disposed in the opaque region 312 of the vehicle glass. Meanwhile, the transparent electrode part may be disposed in the transparent region 311 of the vehicle glass to ensure the invisibility of the antenna from outside of the vehicle glass.

A portion of the transparent electrode part may be attached to the opaque region 312 in some cases. The frit pattern of the opaque region 312 may be gradated from the opaque region 312 to the transparent region 311. Transmission efficiency of a transmission line may be improved while the invisibility of the antenna may be improved in a manner of matching the light transmittance of the frit pattern with the light transmittance of the transparent electrode part within a certain range. Meanwhile, a metal mesh shape similar to the frit pattern may reduce sheet resistance while ensuring invisibility. In addition, the risk of disconnection of the transparent electrode layer during manufacturing and assembly may be reduced by increasing a line width of a metal mesh grid in a region connected to the opaque substrate 1010b.

Referring to (a) of FIGS. 6A and 6B, a conductive pattern 1110 of the antenna module may include metal mesh grids with the same line width on the opaque region 312. The conductive pattern 1110 may include a connection pattern 1110c for connecting the transparent substrate 1010a and the opaque substrate 1010b. On the opaque region 312, the connection pattern 1110c and the frit patterns of a predetermined shape on both side surfaces of the connection pattern 1110c may be disposed at certain intervals. The connection pattern 1110c may include a first transmittance portion 1111c configured to have a first transmittance and a second transmittance portion 1112c configured to have a second transmittance.

The frit patterns 312A disposed in the opaque region 312 may include metal grids of a certain diameter arranged in one axial direction and another axial direction. The metal grids of the frit patterns 312A are the second transmittance portion 1112c of the connection pattern 1110c may be disposed at intersections of the metal mesh grids.

Referring to (b) of FIGS. 6A and 6B, the frit patterns 312B disposed in the opaque region 312 may include slot grids of a certain diameter, from which a metal region has been removed, disposed in one axial direction and another axial direction. The slot grids of the frit patterns 312B may be disposed between the metal mesh grids in the connection pattern 1110c. Accordingly, the metal regions of the frit patterns 312B where slot grids are not disposed may be disposed at the intersections of the metal mesh grids.

Referring to FIGS. 6A and 6C, the connection pattern 1110c may include metal mesh grids with a first line width W1 in the first transmittance portion 1111c adjacent to the transparent region 311. The connection pattern 1110c may be configured to have a second line width W2 thicker than the first line width W1 in the second transmittance portion 1112c adjacent to the opaque substrate 1010b. In this regard, the first transparency of the first transmittance portion 1111c may be set higher than the second transparency of the second transmittance portion 1112c.

When the transparent antenna assembly is attached to the inside of the vehicle glass as illustrated in FIGS. 5A to 5C, the transparent electrode part may be disposed in the transparent region 311 and the opaque substrate 1010b may be disposed in the opaque region 312. In this regard, the transparent electrode part may be disposed in the opaque region 312 in some cases.

Metal patterns of a low-transmittance pattern electrode part and a high-transmittance pattern electrode part located on the opaque region 312 may partially be disposed in a gradient region of the opaque region 312. If the antenna pattern and a transmission line portion of the low-transmittance pattern electrode part is configured as a transparent electrode, a decrease in antenna gain may be caused by a decrease in transmission efficiency due to an increase in sheet resistance. As a way to overcome this loss of gain, the transmittance of the frit pattern 312 where an electrode is located and the transmittance of the transparent electrode may be made to match each other within a certain range.

Low sheet resistance may be achieved by increasing the line width of the transparent electrode located on a region where the transmittance of the frit pattern 312A, 312B, 312c is low or by adding the same shape as that of the frit pattern 312A, 312B, 312c. Accordingly, invisibility may be secured while solving the problem of reduced transmission efficiency. The transmittance and pattern of the opaque region 312 are not limited to those in the structure of FIG. 6A and may differ depending on a glass manufacturer or vehicle manufacturer. Accordingly, the shape and transparency (line width and spacing) of the transparent electrode of the transmission line may change in various ways.

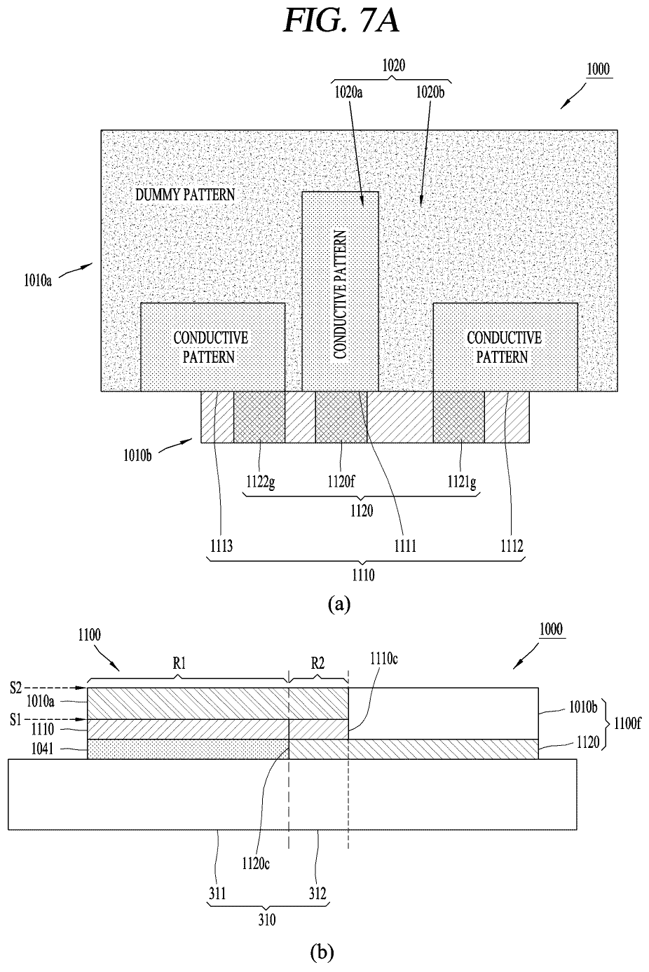

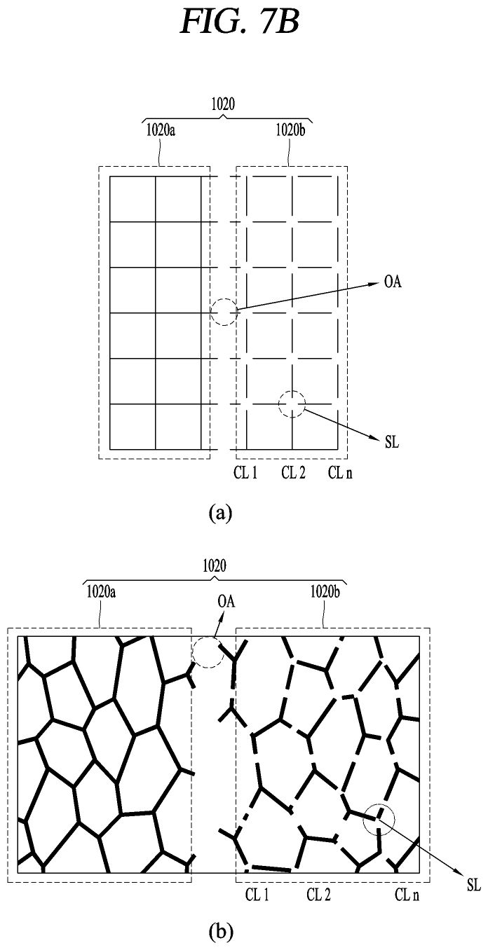

FIG. 7A shows a front view and a cross-sectional view of a transparent antenna assembly according to the present disclosure. FIG. 7B is a diagram illustrating a grid structure of a metal mesh radiator region and a dummy metal mesh region according to embodiments.

(a) of FIG. 7A illustrates a front view of the transparent antenna assembly 1000, and (b) of FIG. 7A is a cross-sectional view of the transparent antenna assembly 1000, showing the layered structure of the transparent antenna assembly 1000. Referring to FIG. 7A, the antenna assembly 1000 may include the first transparent dielectric substrate 1010a and the second dielectric substrate 1010b. Conductive patterns 1110 that act as radiators may be disposed on one surface of the first transparent dielectric substrate 1010a. A feed pattern 1120f and ground patterns 1121g and 1122g may be disposed on one surface of the second dielectric substrate 1010b. The conductive patterns 1110 acting as radiators may be configured to include one or more conductive patterns. The conductive patterns 1110 may include a first pattern 1111 connected to the feed pattern 1120f, and a second pattern 1112 connected to the ground pattern 1121g. The conductive patterns 1110 may further include a third pattern 1113 connected to the ground pattern 1122g.

The conductive patterns 1110 constituting the antenna module may be implemented as transparent antennas. Referring to FIG. 7B, the conductive patterns 1110 may be metal grid patterns 1020a with a certain line width or less to form a metal mesh radiator region. Dummy metal grid patterns 1020b may be disposed in inner regions between or outer regions of the first to third patterns 1111, 1112, and 11113 of the conductive patterns 1100 to maintain transparency at a certain level. The metal grid patterns 1020a and the dummy metal grid patterns 1020b may form a metal mesh layer 1020.

(a) of FIG. 7B illustrates a typical structure of the metal grid patterns 1020a and the dummy metal grid patterns 1020b. (b) of FIG. 7 illustrates an atypical structure of the metal grid patterns 1020a and the dummy metal grid patterns 1020b. As illustrated in(a) of FIG. 7B, the metal mesh layer 1020 may be configured to have a transparent antenna structure by a plurality of metal mesh grids. The metal mesh layer 1020 may be configured to have a typical metal mesh shape, such as a square shape, a diamond shape, or a polygonal shape. Conductive patterns may be configured such that the plurality of metal mesh grids operate as feeding lines or radiators. The metal mesh layer 1020 may constitute a transparent antenna region. As one example, the metal mesh layer 1020 may have a thickness of about 2 mm, but is not limited thereto.

The metal mesh layer 1020 may include the metal grid patterns 1020a and the dummy metal grid patterns 1020b. The metal grid patterns 1020a and the dummy metal grid patterns 1020b may have end portions disconnected from each other to configure an opening area (opened region) OA, thereby being electrically disconnected. The dummy metal grid patterns 1020b may have slits SL configured so that end portions of mesh grids CL1, CL2, . . . , CLn are not connected.

Referring to (b) of FIG. 7B, the metal mesh layer 1020 may be constituted by a plurality of atypical metal mesh grids. The metal mesh layer 1020 may include the metal grid patterns 1020a and the dummy metal grid patterns 1020b. The metal grid patterns 1020a and the dummy metal grid patterns 1020b may have end portions disconnected from each other to form the opened region OA, thereby being electrically disconnected. The dummy metal grid patterns 1020b may have slits SL disposed so that end portions of mesh grids CL1, CL2, . . . , CLn are not connected.

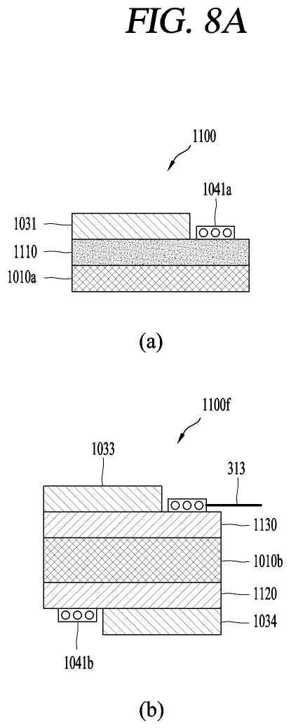

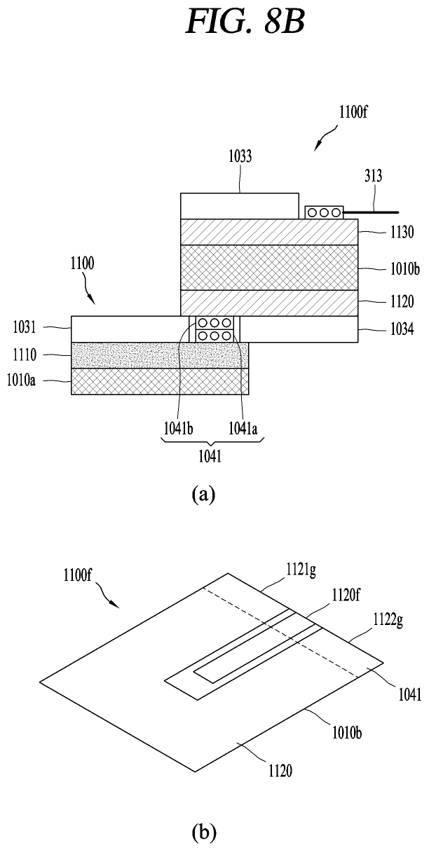

Meanwhile, the transparent substrate on which the transparent antenna according to the present disclosure is disposed may be disposed on the vehicle glass. In this regard, FIG. 8A illustrates a layered structure of an antenna module and a feed pattern. FIG. 8B illustrates an opaque substrate including the layered structure, in which the antenna module and the feeding structure are coupled to each other, and a coupled portion.

Referring to (a) of FIG. 8A, the antenna module 1100 may include a first transparent dielectric substrate 1010a disposed on a first layer, and a first conductive pattern 1110 disposed on a second layer disposed on the first layer. The first conductive pattern 1110 may be implemented as the metal mesh layer 1020 including the metal grid patterns 1020a and the dummy metal grid patterns 1020b, as illustrated in FIG. 7B. The antenna module 1100 may further include a protective layer 1031 and an adhesive layer 1041a disposed on the second layer.

Referring to (b) of FIG. 8A, a feeding structure 1100f may include a second dielectric substrate 1010b, a second conductive pattern 1120, and a third conductive pattern 1130. The feeding structure 1100f may further include first and second protective layers 1033 and 1034 stacked on the second conductive pattern 1120 and the third conductive pattern 1130, respectively. The feeding structure 1100f may further include an adhesive layer 1041b disposed in a partial region of the second conductive pattern 1120.

The second conductive pattern 1120 may be disposed on one surface of the second dielectric substrate 1010b implemented as an opaque substrate. The third conductive pattern 1130 may be disposed on another surface of the second dielectric substrate 1010b. The first protective layer 1033 may be disposed on the top of the third conductive pattern 1130. The second protective layer 1034 may be disposed on the bottom of the second conductive pattern 1120. Each of the first and second protective layers 1033 and 1034 may be configured to have a low permittivity below a certain value, enabling low-loss feeding to the transparent antenna region.

Referring to (a) of FIG. 8B, the antenna module 1100 may be coupled with the feeding structure 1100f including the second dielectric substrate 1010b, which is the opaque substrate. The first conductive pattern 1110 implemented as the metal mesh layer, which is the transparent electrode layer, may be disposed on the top of the first transparent dielectric substrate 1010a. The protective layer 1031 may be disposed on the top of the first conductive pattern 1110. The protective layer 1031 and the first adhesive layer 1041a may be disposed on the top of the first conductive pattern 1110. The first adhesive layer 1041a may be disposed adjacent to the protective layer 1031.

The first adhesive layer 1041a disposed on the top of the first conductive pattern 1110 may be bonded to the second adhesive layer 1041b disposed on the bottom of the second conductive layer 1120. The first transparent dielectric substrate 1010a and the second dielectric substrate 1010b may be adhered by the bonding between the first and second adhesive layers 1041a and 1041b. Accordingly, the metal mesh grids disposed on the first transparent dielectric substrate 1010a may be electrically connected to the feed patterns disposed on the second dielectric substrate 1010b.

The second dielectric substrate 1010b may be disposed as the feeding structure 1100f that have the second conductive pattern 1120 and the third conductive pattern 1130 disposed on one surface and another surface thereof. The feeding structure 1100f may be implemented as a flexible printed circuit board (FPCB), but is not limited thereto. The first protective layer 1033 may be disposed on the top of the third conductive pattern 1130, and the second protective layer 1034 may be disposed on the bottom of the second conductive pattern 1120. The adhesive layer 1041b on the bottom of the third conductive pattern 1130 may be bonded to the adhesive layer 1041a of the antenna module 1100. Accordingly, the feeding structure 1100f may be coupled with the antenna module 1100 and the first and second conductive patterns 1110 and 1120 may be electrically connected.

The antenna module 1100 implemented using the first transparent dielectric substrate 1010a may be configured to have a first thickness. The feeding structure 1100f implemented with the second dielectric substrate 1010b may be configured to have a second thickness. For example, the thicknesses of the dielectric substrate 1010a, the first conductive pattern 1110, and the protective layer 1031 of the antenna module 1100 may be 75 μm, 9 μm, and 25 μm, respectively. The first thickness of the antenna module 1100 may be 109 μm. The thicknesses of the second dielectric substrate 1010b, the second conductive pattern 1120, and the third conductive pattern 1130 of the feeding structure 1100f may be 50 μm, 18 μm, and 18 μm, respectively, and the thicknesses of the first and second protective layers 1033 and 1034 may be 28 μm. Accordingly, the second thickness of the feeding structure 1100f may be 142 μm. Since the adhesive layers 1041a and 1041b are disposed on the top of the first conductive pattern 1110 and the bottom of the second conductive pattern 1120, the entire thickness of the antenna assembly may be smaller than the sum of the first thickness and the second thickness. For example, the antenna assembly 1000 including the antenna module 1100 and the feeding structure 1100f may have a thickness of 198 μm.

Referring to (b) of FIG. 8B, the conductive pattern 1120 may be disposed on one surface of the second dielectric substrate 1010b forming the feeding structure 1100f. The conductive pattern 1120 may be configured to have a CPW type feeding structure that includes the feed pattern 1120f and ground patterns 1121g and 1122g disposed on both sides of the feed pattern 1120f. The feeding structure 1100f may be coupled with the antenna module 1100, as illustrated in (a) of FIG. 8B, through a region where an adhesive layer 1041 is disposed.

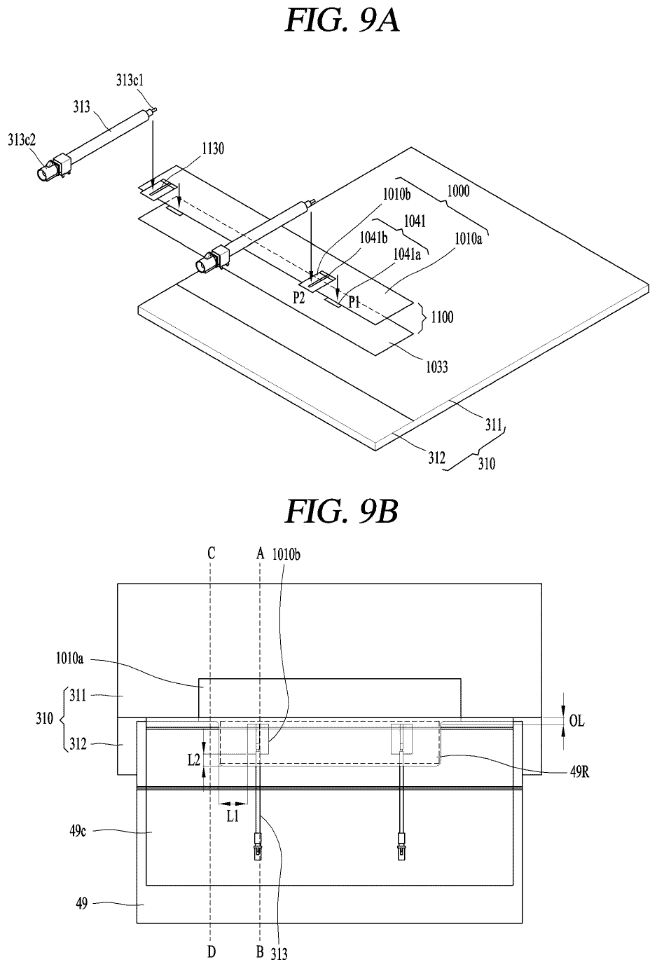

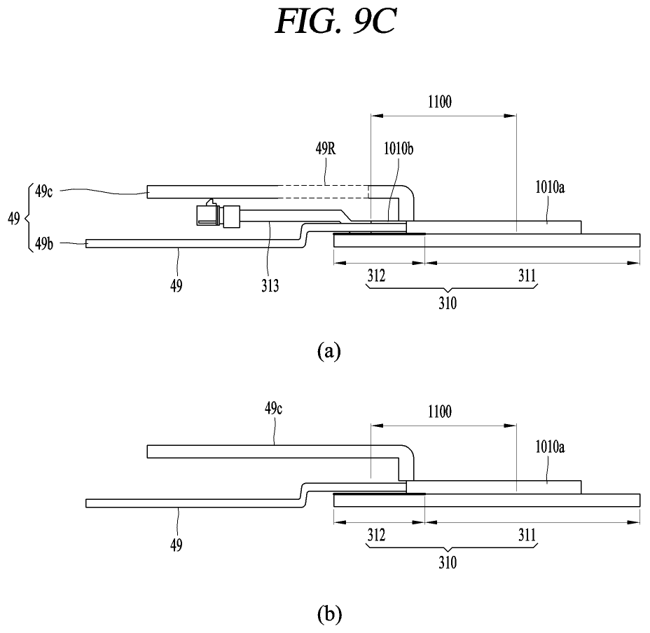

The antenna module and the feeding structure constituting the antenna assembly according to the present disclosure may be disposed on the vehicle glass and coupled through a specific coupling structure. In this regard, FIG. 9A illustrates a coupling structure of a transparent antenna that is disposed in a transparent region and a frit region of vehicle glass.

Referring to FIG. 9A, the first transparent dielectric substrate 1010a may be adhered to the glass panel 310 through the adhesive layer 1041. The conductive pattern of the first transparent dielectric substrate 1010a may be bonded to the conductive pattern 1130 of the second dielectric substrate 1010b through ACF bonding. ACF bonding involves bonding a tape, to which metal balls are added, to a bonding surface at high temperature/high pressure (e.g., 120 to 150 degrees, 2 to 5 Mpa) for a few seconds, and may be achieved by allowing electrodes to be in contact with each other through the metal ball therebetween. ACF bonding electrically connects conductive patterns and simultaneously provides adhesive strength by thermally hardening the adhesive layer 1041.

The first transparent dielectric substrate 1010a on which the transparent electrode layer is disposed and the second dielectric substrate 1010b in the form of the FPCB may be attached to each other using a local soldering technique. The connection pattern of the FPCB and the transparent antenna electrode may be connected through local soldering using a coil in a magnetic field induction manner. During such local soldering, the FPCB may be maintained flat without deformation due to an increase in temperature of a soldered portion. Accordingly, an electrical connection with high reliability may be achieved through the local soldering between the conductive patterns of the first transparent dielectric substrate 1010a and the second dielectric substrate 1010b.

The first transparent dielectric substrate 1010a, and the metal mesh layer 1020 of FIG. 7A, the protective layer 1033, and the adhesive layer 1041 may form a transparent electrode. The second dielectric substrate 1010b, which is an opaque substrate, may be implemented as the FPCB, but is not limited thereto. The second dielectric substrate 1010b, which is the FPCB with the feed pattern, may be connected to the connector part 313 and the transparent electrode.

The second dielectric substrate 1010b, which is the opaque substrate, may be attached to a partial region of the first transparent dielectric substrate 1010a. The first transparent dielectric substrate 1010a may be disposed in the transparent region 311 of the glass panel 310. The second dielectric substrate 1010b may be disposed in the opaque region 312 of the glass panel 310. The partial region of the first transparent dielectric substrate 1010a may be disposed in the opaque region 312, and the first transparent dielectric substrate 1010a may be coupled to the second dielectric substrate 1010b on the opaque region 312.

The first transparent dielectric substrate 1010a and the second dielectric substrate 1010b may be adhered by bonding between the adhesive layers 1041a and 1041b. A position at which the second dielectric substrate 1010b is bonded to the adhesive layer 1041 may be set to a first position P1. A position at which the connector part 313 is soldered to the opaque substrate 1010b may be set to a second position P2.

Meanwhile, the vehicle glass on which the antenna assembly according to the present disclosure is disposed may be coupled to a body structure of the vehicle. In this regard, FIG. 9B is an enlarged front view of a region where glass with the transparent antenna of FIG. 9A is coupled to a body structure of the vehicle. FIG. 9C is a cross-sectional view illustrating the coupling structure between the vehicle glass and the body structure of FIG. 9B, viewed from different positions.

Referring to FIG. 9B, the first transparent dielectric substrate 1010a on which a transparent antenna is placed may be disposed in the transparent region 311 of the glass panel 310. The second dielectric substrate 1010b may be disposed in the opaque region 312 of the glass panel 310. Since the transmittance of the opaque region 312 is lower than that of the transparent region 311, the opaque region 312 may also be referred to as a black matrix (BM) region. A portion of the first transparent dielectric substrate 1010a on which the transparent antenna is disposed may extend up to the opaque region 312 corresponding to the BM region. The first transparent dielectric substrate 1010a and the opaque region 312 may be disposed to overlap each other by an overlap length OL in one axial direction.

(a) of FIG. 9C is a cross-sectional view of the antenna assembly, cut along the line AB in FIG. 9B. (a) of FIG. 9C is a cross-sectional view of the antenna assembly, cut along the line CD in FIG. 9B.

Referring to FIG. 9B and (a) of FIG. 9C, the first transparent dielectric substrate 1010a on which the transparent antenna is arranged may be disposed in the transparent region 311 of the glass panel 310. The second dielectric substrate 1010b may be disposed in the opaque region 312 of the glass panel 310. The partial region of the first transparent dielectric substrate 1010a may extend up to the opaque region 312, so that the feed pattern disposed on the second dielectric substrate 1010b and the metal mesh layer of the transparent antenna may be bonded to each other.

An interior cover 49c may be configured to accommodate the connector part 313 connected to the second dielectric substrate 1010b. The connector part 313 may be disposed in a space between a body 49b made of a metal material and the interior cover 49c, and the connector part 313 may be coupled to an in-vehicle cable. The interior cover 49c may be disposed in an upper region of the body 49b made of the metal material. The interior cover 49c may be disposed with one end portion bent to be coupled to the body 49b made of the metal material.

The interior cover 49c may be made of a metal material or dielectric material. When the interior cover 49c is made of the metal material, the interior cover 49c and the body 49b made of the metal material constitute a metal frame 49. In this regard, the vehicle may include the metal frame 49. The opaque region 312 of the glass panel 310 may be supported by a portion of the metal frame 49. To this end, a portion of the body 49b of the metal frame 49 may be bent to be coupled to the opaque region 312 of the glass panel 310.

When the interior cover 49c is made of the metal material, at least a portion of a metal region of the interior cover 49c on the upper region of the second dielectric substrate 1010b may be removed. A recess portion 49R from which the metal region has been removed may be disposed in the interior cover 49c. Accordingly, the metal frame 49 may include the recess portion 49R. The second dielectric substrate 1010b may be disposed within the recess portion 49R of the metal frame 49.

The recess portion 49R may also be referred to as a metal cut region. One side of the recess portion 49R may be disposed to be spaced apart from one side of the opaque substrate 1010b by a first length L1 which is equal to or greater than a threshold value. A lower boundary side of the recess portion 49R may be disposed to be spaced apart from a lower boundary side of the opaque substrate 1010b by a second length L2 which is equal to or greater than a threshold value. As a metal is removed from a partial region of the interior cover 49c made of the metal material, signal loss and changes in antenna characteristics due to a surrounding metal structure may be suppressed.

Referring to FIG. 9B and (b) of FIG. 9C, a recess portion like a metal cut region may not be disposed in the interior cover 49c on a region where the connector part and the opaque substrate are not disposed. In this regard, while protecting the internal components of the antenna module 1100 by use of the interior cover 49c, internal heat may be dissipated to the outside through the recess portion 49R of FIG. 9B and (a) of FIG. 9C. In addition, whether it is necessary to repair a connected portion may be immediately determined through the recess portion 49R of the interior cover 49c. Meanwhile, a recess portion may not be disposed in the interior cover 49c on the region where the connector part and the second dielectric substrate are not disposed, which may result in protecting the internal components of the antenna module 1100.

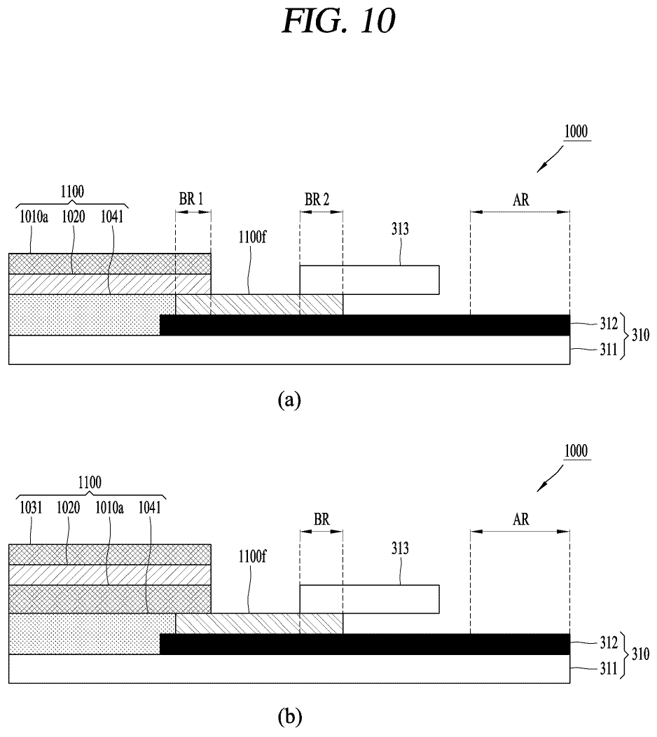

Meanwhile, the antenna assembly 1000 according to the present disclosure may be configured in various shapes on the glass panel 310, and the glass panel 310 may be attached to the vehicle frame. In this regard, FIG. 10 illustrates a stacked structure of an antenna assembly and an attachment region between vehicle glass and a vehicle frame according to embodiments.

Referring to (a) of FIG. 10, the glass panel 310 may include the transparent region 311 and the opaque region 312. The antenna assembly 1000 may include the antenna module 1100 and the feeding structure 1100f. The antenna module 1100 may include the first transparent dielectric substrate 1010a, the transparent electrode layer 1020, and the adhesive layer 1041. The feeding structure 1100f implemented as the opaque region and the transparent electrode layer 1020 implemented as the transparent substrate may be electrically connected to each other. The feeding structure 1100f and the transparent electrode layer 1020 may be directly connected through a first bonding region BR1. The feeding structure 1100f and the connector part 313 may be directly connected through a second bonding region BR2. Heat may be applied for bonding in the first and second bonding regions BR1 and BR2. Accordingly, the bonding regions BR1 and BR2 may be referred to as heating sections. An attachment region AR corresponding to a sealant region for attachment of the glass panel 310 to the vehicle frame may be disposed in a side end area on the opaque region 312 of the glass panel 310.

Referring to (b) of FIG. 10, the glass panel 310 may include the transparent region 311 and the opaque region 312. The antenna assembly 1000 may include the antenna module 1100 and the feeding structure 1100f. The antenna module 1100 may include the protective layer 1031, the transparent electrode layer 1020, the first transparent dielectric substrate 1010a, and the adhesive layer 1041. The feeding structure 1100f implemented as the opaque region may overlap a partial region of the antenna module 1100 implemented as the transparent substrate. The feeding structure 1100f and the transparent electrode layer 1020 of the antenna module 1100 may be connected in a coupling feeding manner. The feeding structure 1100f and the connector part 313 may be directly connected through a bonding region BR. Heat may be applied for bonding in the bonding region BR1. Accordingly, the bonding region BR may be referred to as a heating section. An attachment region AR corresponding to a sealant region for attachment of the glass panel 310 to the vehicle frame may be disposed in a side end area on the opaque region 312 of the glass panel 310.

Referring to (a) and (b) of FIG. 10, the transparent substrate 1010a may include a (hard) coating layer to protect the transparent electrode layer 1020 from an external environment. Meanwhile, a UV-cut component may be added to the adhesive layer 1041 to suppress yellowing from sunlight.

A broadband transparent antenna structure according to the disclosure, which may be disposed on glass of a vehicle, may be implemented as a single dielectric substrate on the same plane as a CPW feeder. In addition, a broadband transparent antenna structure according to the disclosure, which may be disposed on glass of a vehicle, may be implemented as a structure in which grounds are disposed at both sides of a radiator so as to constitute a broadband structure.

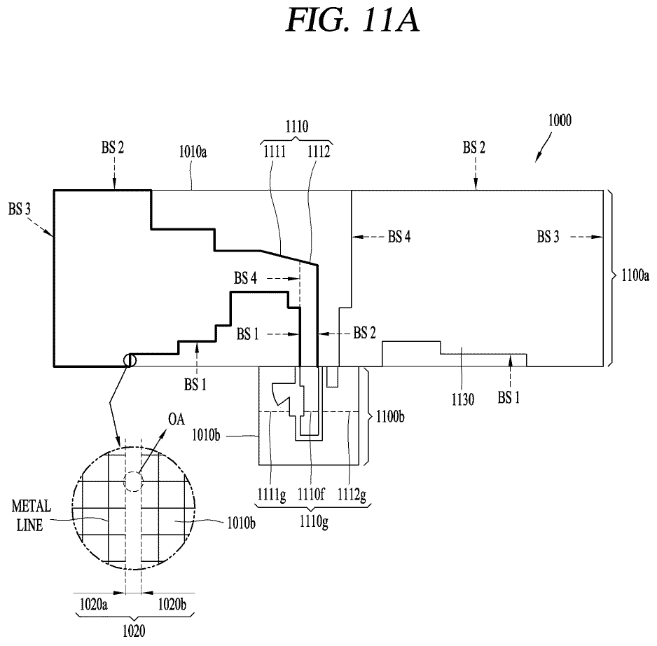

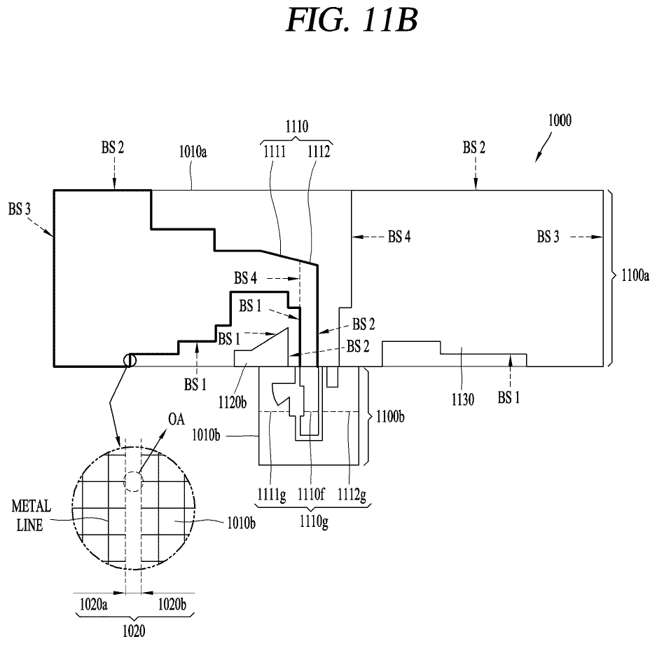

Hereinafter, an antenna assembly associated with a broadband transparent antenna structure according to the present disclosure will be described. In this regard, FIGS. 11A and 11B are front views of an antenna assembly according to the present disclosure.

Referring to FIGS. 11A and 11B, the antenna assembly 1000 may be configured to include the dielectric substrate 1010a, a first region 1100a, and a second region 1100b. The region 1100a may include conductive patterns on one side surface of the dielectric substrate 1010 and configured to radiate radio signals. The second region 1100b may be configured to include a grounded (ground) conductive pattern 1110g and a feed pattern 1110f. The first region 1100a and the second region 1100b may also be referred to as a radiator region and a ground region (or a feed region), respectively.

A plurality of conductive patterns disposed in the first region 1100a of the antenna assembly 1000 may be implemented as two or more conductive patterns and configured to operate in a plurality of frequency bands. Referring to FIG. 11A, the plurality of conductive patterns disposed in the first region 1100a may be configured to include the first conductive pattern 1110 and the third conductive pattern 1130. Referring to FIG. 11B, the plurality of conductive patterns may be configured to include the first conductive pattern 1110, the second conductive pattern 1120, and the third conductive pattern 1130.

The first conductive pattern 1110 may include a plurality of sub patterns, namely, a plurality of conductive portions. The first conductive pattern 1110 may be configured to include a first portion 1111 and a second portion 1112. The first portion 1111 may be disposed perpendicularly to the second portion 1112. The second portion 1112 may be electrically connected to the feed pattern 1110f. In relation to this, the expression “electrically connected” may indicate conductive portions being directly connected to each other or spaced apart by a certain gap to be coupled and connected to each other.

Referring to FIGS. 11A and 11B, the third conductive pattern 1130 may be disposed in another side region of the first conductive pattern 1110. The third conductive pattern 1130 may be electrically connected to a second portion 1112g of the ground conductive pattern 1110g.

Referring to FIG. 11B. the second conductive pattern 1120 may be disposed in a region at one side of or in a region below the first conductive pattern 1110. The second conductive pattern 1120 may be electrically connected to a first portion 1111g of the ground conductive pattern 1110g. The second conductive pattern 1120 may further be placed on the antenna assembly 1000 to further resonate in a frequency band other than operating frequency bands of the first conductive pattern 1110 and the third conductive pattern 1130.

The second conductive pattern 1120 may be configured to have a size smaller than that of the third conductive pattern 1130. Accordingly, the antenna assembly 1000 may operate as a radiator in a higher frequency band due to the second conductive pattern 1120. The second conductive pattern 1120 may be arranged between the first portion 1111 of the first conductive pattern 1110 and the second portion 1112 of the first conductive pattern 1110. Accordingly, the second conductive pattern 1120 may be arranged in the lower region of the first conductive pattern 1110, and a size of the antenna assembly 1000 may be reduced compared to when the second conductive pattern 1120 is arranged in one side region of the first conductive pattern 1110. The first portion 1111 of the first conductive pattern 1110 and the third conductive pattern 1130 may be placed at opposite sides with reference to the second portion 1112 of the first conductive pattern 1110. The first portion 1111 of the first conductive pattern 1110 and the third conductive pattern 1130 may be placed on one side region and another side region with reference to the second portion 1112 of the first conductive pattern 1110.

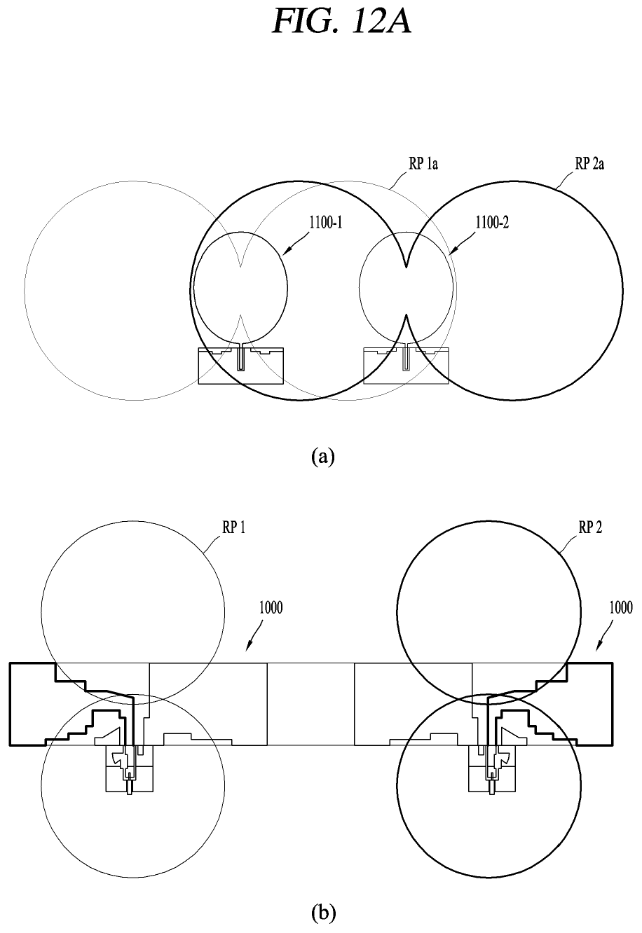

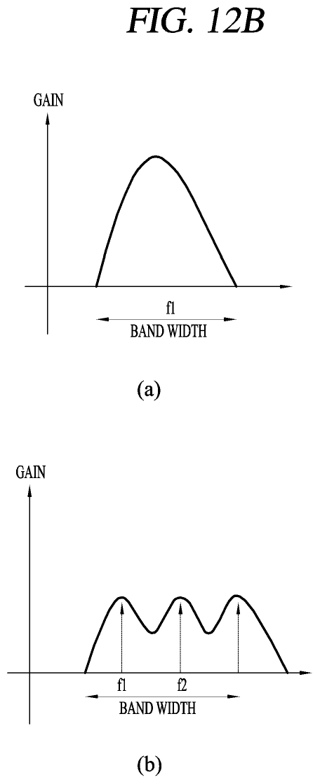

The antenna assembly according to the present disclosure may operate in a wide band to perform 4G wireless communication and 5G wireless communication. In addition, the antenna assembly according to the present disclosure may operate in a dipole antenna mode to reduce interference between antenna elements during multiple input multiple output (MIMO) operation. In relation to this, FIG. 12A shows comparison between a radiation pattern of a monopole antenna operating in a single band and a radiation pattern of the antenna assembly according to the present disclosure. FIG. 12B shows comparison between gain characteristics of the monopole antenna of FIG. 12A and gain characteristics of the antenna assembly according to the present disclosure.

Referring to (a) of FIG. 12A, radiation patterns RP1a and RP2a of monopole antennas 1100-1 and 1100-2 are defined in a direction parallel to antenna elements, respectively. That is, radiation patterns are defined in one side direction and another side direction of the antenna elements. Therefore, when monopole antennas 1100a are spaced apart from each other to perform MIMO operation, interference between the antenna elements may occur.

On the other hand, referring to (b) of FIG. 12A, radiation patterns RP1 and RP2 of antenna assemblies 1000 are defined in a direction perpendicular to an antenna arrangement. That is, radiation patterns are defined in an upper direction and a lower direction of the antenna elements. Therefore, even when the antenna assemblies 1000 are spaced apart from each other to perform MIMO operation, interference between the antenna elements may be minimized to a certain level or less.

Referring to (a) of FIG. 12A and (a) of FIG. 12B, the monopole antennas 1100-1 and 1100-2 operate to resonate in a single frequency band. The monopole antennas 1100-1 and 1100-2 operate as a radiator only within a certain frequency band with reference to a center frequency f1. Thus, a whole frequency band for 4G/5G wireless communications may not be covered.

On the other hand, referring to (b) of FIG. 12A and (b) of 12B, the antenna assemblies 1000 operate to resonate in a plurality of frequency bands. The antenna assemblies 1000 operate as radiators in all of first to third frequency bands with reference to a plurality of resonant frequencies, e.g., frequencies f1, f2 and f3. The assemblies 1000 may operate in first, second and third modes in the first, second and third frequency bands, respectively. Accordingly, the antenna assemblies 1000 may operate as radiators in all of the low band (LB), the mid band (MB), the high band (HB) and the 5G Sub6 band for 4G/5G wireless communication.

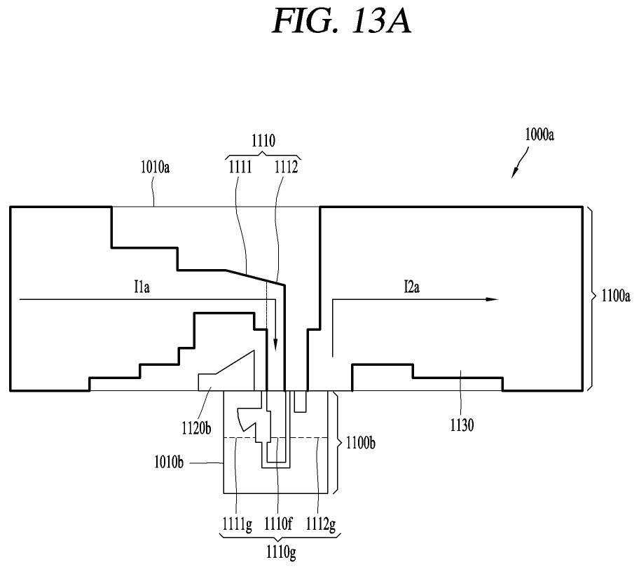

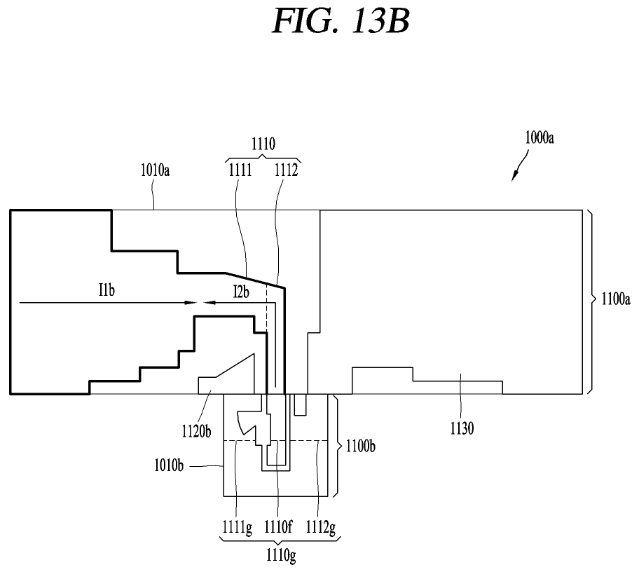

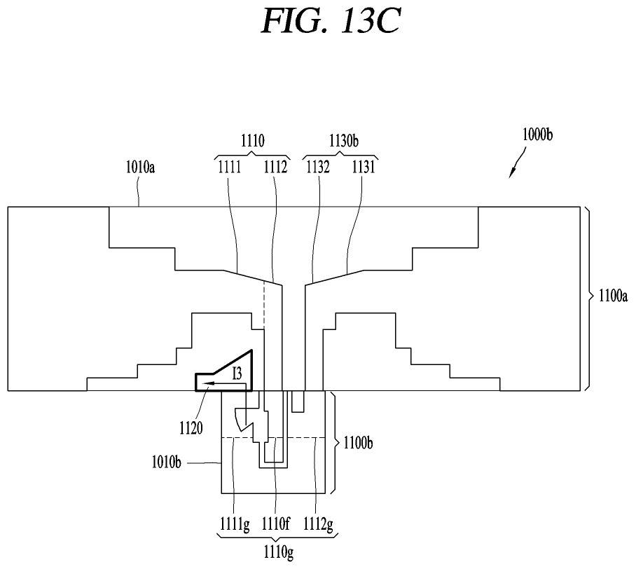

To do so, the antenna assemblies 1000 may operate as radiators through each of a plurality of conductive patterns of the antenna assembly 1000 and a combination thereof may operate as radiators in each frequency band. FIGS. 13A to 13C are conceptual diagrams illustrating an operating principle of the antenna assembly 1000 of FIG. 11B in each frequency band.

Referring to FIGS. 11B, 12B, and 13A, the antenna assembly 1000 may operate in a dipole antenna mode in a first frequency band of 617 to 960 MHz. The first frequency band is not limited thereto, and may be changed depending on application for 4G/5G LB communication. The first conductive pattern 1110 and the third conductive pattern 1130 may operate in a dipole antenna mode in the first frequency band. In this regard, a first current Ila may be supplied from the first portion 1111 of the first conductive pattern 1110 to the second portion 1112 of the first conductive pattern 1110 in the first frequency band. In addition, a second current I2a supplied through the third conductive pattern 1130 in the first frequency band may be supplied in a direction opposite to that of the first current Ila supplied through the first conductive pattern 1110. Accordingly, the first conductive pattern 1110 and the third conductive pattern 1130 may operate in a dipole antenna mode in the first frequency band.

The first conductive pattern 1110 and the third conductive pattern 1130 may be configured to have an asymmetrical structure. The first conductive pattern 1110 may be configured as a step structure in which a plurality of conductive portions have different heights. The third conductive pattern 1130 may be configured to include an upper region with a linear structure in which a plurality of conductive portions have a linear shape. The third conductive pattern 1130 may have end portions of a lower region disposed at different points for impedance matching.

Referring to FIGS. 11B, 12B, and 13B, the antenna assemblies 1000 may operate in a monopole antenna mode in the second frequency band of 1520 to 4500 MHz. In this regard, the second frequency band may be changed to a frequency higher than the first frequency band depending on application for 4G/5G MB/HB communication. The first conductive pattern 1110 may operate in a monopole antenna mode in the second frequency band. In this regard, a first current I1b may be supplied from the first portion 1111 of the first conductive pattern 1110 to the second portion 1112 of the first conductive pattern 1110 in the second frequency band. In addition, a second current I2b may be supplied from the second portion 1112 of the first conductive pattern 1110 to the first portion 1111 of the first conductive pattern 1110 in the second frequency band. Accordingly, the first conductive pattern 1110 may operate in a monopole antenna mode in the second frequency band.

Since the second frequency band is set to a value greater than the first frequency band, even in operation in a monopole antenna mode in the second frequency band, interference between a plurality of antenna elements is smaller than in the first frequency band. Accordingly, the antenna assemblies 1000 operate in a dipole antenna mode to prevent interference between antenna elements in the first frequency band. The antenna assemblies 1000 operate in a monopole antenna mode in the second frequency band for wideband operation.

Referring to FIGS. 11B, 12B and 13C, the antenna assemblies 1000 may operate as radiators through additional resonance in a third frequency band of 4500 to 6000 MHz. In this regard, a third current I3 may be supplied in the second conductive pattern 1120 in the third frequency band. The third current I3 may be supplied in the second conductive pattern 1120 in the third frequency band. Accordingly, the third conductive pattern 1130 may operate as a radiator in the third frequency band.

In this regard, the third frequency band may be changed to a frequency higher than the second frequency band for 4G/5G UHB and 5G Sub6 communication depending on application. The second conductive pattern 1120 may operate as a radiator in the third frequency band higher than the second frequency band. Accordingly, the antenna assemblies 1000 may also operate as radiators in the third frequency band in addition to the first and second frequency bands, thereby covering a whole frequency band for 4G/5G wireless communication.

The first conductive pattern 1110 is combined with the third conductive pattern 1130 to operate in the monopole antenna mode in the first frequency band, and operates separately in the dipole antenna mode in the second frequency band. To do so, a shape of the first conductive pattern 1110 may be configured to have a step structure to be optimized for wideband operation. In this regard, the first conductive pattern 1110 may be configured to have a plurality of boundary sides.

Referring to FIGS. 11A, 11B, and 13A to 13C, the first portion 1111 of the first conductive pattern 1110 may be configured to have a plurality of boundary sides. The first portion 1111 of the first conductive pattern 1110 may be configured to have a first boundary side BS1 to a fourth boundary side BS4.

The first boundary side BS1 of the first portion 1111 of the first conductive pattern 1110 may be configured to have a first step structure. The second boundary side BS2 of the first portion 1111 of the first conductive pattern 1110 may be configured to have a second step structure. The second step structure may be configured to have a shape different from that of the first step structure.

The third boundary side BS3 of the first portion 1111 of the first conductive pattern 1110 may be arranged between a first end portion of the first boundary side BS1 of the first portion 1111 of the first conductive pattern 1110 and a first end portion of the second boundary side BS2 of the first portion 1111 of the first conductive pattern 1110. The fourth boundary side BS4 of the first portion 1111 of the first conductive pattern 1110 may be arranged between a second end portion of the first boundary side BS1 of the first portion 1111 of the first conductive pattern 1110 and a second end portion of the second boundary side BS2 of the first portion 1111 of the first conductive pattern 1110. Accordingly, a shape of the first portion 1111 of the first conductive pattern 1110 may be optimized for wideband operation in the first and second frequency bands.

The second conductive pattern 1120 may also be configured to have first and second boundary sides BS1 and BS2. A part of the first boundary side BS1 of the first portion 1111 of the first conductive pattern 1110 may be disposed to face the first boundary side BS1 of the second conductive pattern 1120. A part of the first boundary side BS1 of the first portion 1111 of the first conductive pattern 1110 may be disposed to face the second boundary side BS2 of the second conductive pattern 1120.

The third conductive pattern 1130 may also be configured to have a plurality of boundary sides to have a step structure. The third conductive pattern 1130 may be configured to have a first boundary side BS1 to a fourth boundary side BS4. The first boundary side BS1 of the third conductive pattern 1130 may be configured to have a third step structure. A first end portion of the first boundary side BS1 of the third conductive pattern 1130 may be connected to the second portion 1112g of the ground conductive pattern 1110g. The second boundary side BS2 of the third conductive pattern 1130 may be placed at a side opposite to the first boundary side BS1 of the third conductive pattern 1130.

The third boundary side BS3 of the third conductive pattern 1130 may be arranged between the first end portion of the first boundary side BS1 of the first conductive pattern and a first end portion of the second boundary side BS2 of the third conductive pattern 1130. The fourth boundary side BS4 of the third conductive pattern 1130 may be arranged between a second end portion of the first boundary side BS1 of the third conductive pattern 1130 and a second end portion of the second boundary side BS2 of the third conductive pattern 1130. The third boundary side BS3 of the third conductive pattern 1130 may be placed at a side opposite to the fourth boundary side BS4 of the third conductive pattern 1130. A part of the second part 1112 of the first conductive pattern 1110 may be disposed to face the fourth boundary side BS4 of the third conductive pattern 1130.

A length of the third boundary side BS3 of the third conductive pattern 1130 may be configured to be identical to a length of the third boundary side BS3 of the first conductive pattern 1110. Accordingly, the antenna assembly 1000 may be implemented to have a length of the third boundary side BS3 of the first and third conductive patterns 1110 and 1130, and a size of a whole antenna may be minimized.

Meanwhile, the antenna assembly according to the present disclosure may be configured to have a transparent antenna structure. In this regard, referring to FIG. 7B and FIG. 11A, the first conductive pattern 1110 and the third conductive pattern 1130 of the antenna assembly 1000 may be disposed on the dielectric substrate 1010a to have a metal mesh shape 1020 including a plurality of opened regions OA. The first conductive pattern 1110 and the third conductive pattern 1130 may include the metal grid patterns 1020a. The metal grid patterns 1020a may be configured to have the dummy metal grid patterns 1020b and the opened regions OA. The first conductive pattern 1110 and the third conductive pattern 1130 may be configured to have a CPW structure on the dielectric substrate 1010a.

Referring to FIGS. 7B and 11B, the first conductive pattern 1110, the second conductive pattern 1120, and the third conductive pattern 1130 may be configured to have the metal mesh shape 1020 including the plurality of opened regions OA disposed on the dielectric substrate 1010. The first conductive pattern 1110, the second conductive pattern 1120, and the third conductive pattern 1130 may be implemented as a CPW structure on the dielectric substrate 1010. The first conductive pattern 1110, and the second conducive pattern 1120, and the third conductive pattern 1130 may be configured to have the metal grid patterns 1020a. The metal grid patterns 1020a may be configured to have the dummy metal grid patterns 1020b and the opened regions OA. The first conductive pattern 1110, the second conductive pattern 1120, and the third conductive pattern 1130 may be configured as a CPW structure on the dielectric substrate 1010a.

The antenna assembly 1000 may include the plurality of dummy mesh grid patterns 1020b in a radiator region on the dielectric substrate 1010a, i.e., an outside portion of the first region 1100a. Meanwhile, the plurality of dummy mesh grid patterns 1020b may also be placed in dielectric regions between the first to third conductive patterns 1110 to 1130. The plurality of dummy metal grid patterns 1020b may be disposed not to be connected to the feed pattern 1110f and the ground conductive pattern 1110g. The plurality of dummy mesh grid patterns 1020b may be disposed to be separate from each other.

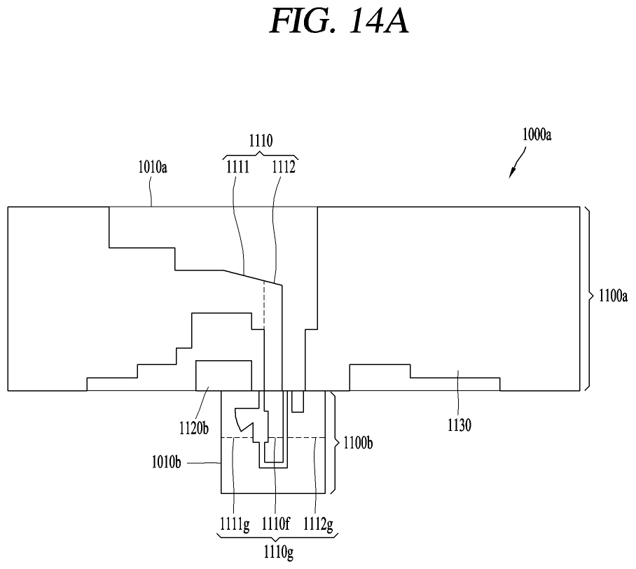

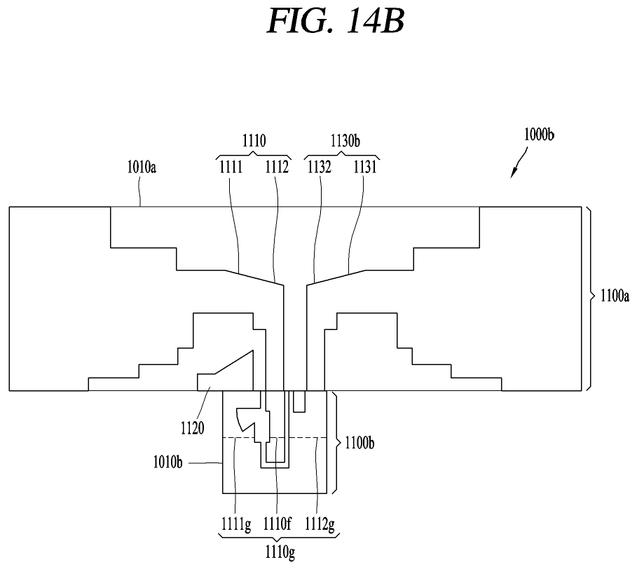

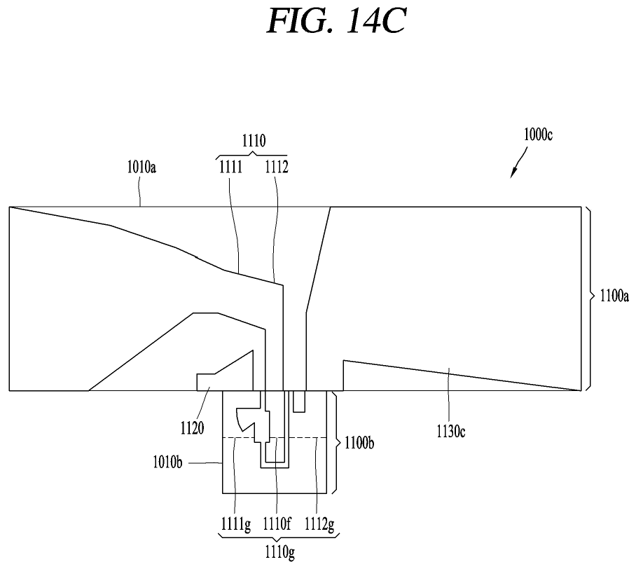

The conductive patterns of the antenna assembly according to the present disclosure may be configured to be changed in various shapes. In relation to this, FIGS. 14A and 14B illustrate structures in which a shape of a second conductive pattern and a shape of a third conductive pattern are changed.

Referring to FIG. 11B, a part of an upper end of the second conductive pattern 1120 of the antenna assembly 1000 may be configured to have a triangular shape. Referring to FIG. 14A, a second conductive pattern 1120b of an antenna assembly 1000a may be configured to have a square shape. The second conductive pattern 1120b may be disposed in a region at one side of or in a region below the first conductive pattern 1110. The second conductive pattern 1120b may be electrically connected to the first portion 1111g of the ground conductive pattern 1110g. The antenna assembly 1000 may operate as a radiator in the third frequency band due to the second conductive pattern 1120b. In relation to this, the antenna assembly 1000 may also operate as a radiator in the third frequency band due to the second conductive pattern 1120. As a shape of the second conductive pattern 1120b is changed, impedance matching characteristics in the third frequency band may be partially changed.

The second conductive pattern 1120b may be configured to have a smaller size that that of the third conductive pattern 1130. Accordingly, the antenna assembly 1000 may operate as a radiator in a higher frequency band, i.e., the third frequency band due to the second conductive pattern 1120b. The second conductive pattern 1120b may be arranged between the first portion 1111 of the first conductive pattern 1110 and the second portion 1112 of the first conductive pattern 1110. Accordingly, the second conductive pattern 1120b may be arranged in a region below the first conductive pattern 1110, and a size of the antenna assembly 1000 may be reduced compared to when the second conductive pattern 1120b is arranged in a region at one side of the first conductive pattern 1110.

Referring to FIG. 14B, a third conductive pattern 1130b of the antenna assembly 1000b may be configured to have a structure symmetrical to the first conductive pattern 1110. Similarly to the first conductive pattern 1110, the third conductive pattern 1130b may be configured to include a first portion 1131 and a second portion 1132. Similarly to the first conductive pattern 1110, the third conductive pattern 1130b may also include an upper end portion and a lower end portion each having a step structure. The third conductive pattern 1130 of FIG. 11B may be configured to have a size larger than that of the third conductive pattern 1130b of FIG. 12B.

Meanwhile, conductive patterns of the antenna assembly according to the present disclosure may be configured to have a continuous structure rather than a step structure. FIG. 14C illustrates a structure in which shapes of first and third conductive patterns are disposed in a continuous structure.

Referring to FIG. 14C, an antenna assembly 1000c may include a first conductive pattern 1110c, the second conductive pattern 1120, and a third conductive pattern 1130c. The first conductive pattern 1110c may be configured to have a structure of continuous connections along respective connection points. The third conductive pattern 1130c may be also configured to have a structure of connections continuous along respective connection points.

Referring to FIGS. 14A and 14B, the first conductive pattern 1110 may be configured to have a step structure in a vertical direction along respective connection points. Accordingly, a current component in a vertical direction may increase in the first conductive pattern 1110 having the step structure. The third conductive patterns 1130 and 1130b may be each configured to have a step structure in a vertical direction along respective connection points. Accordingly, a current component in a vertical direction may increase in the third conductive pattern 1110 having the step structure.

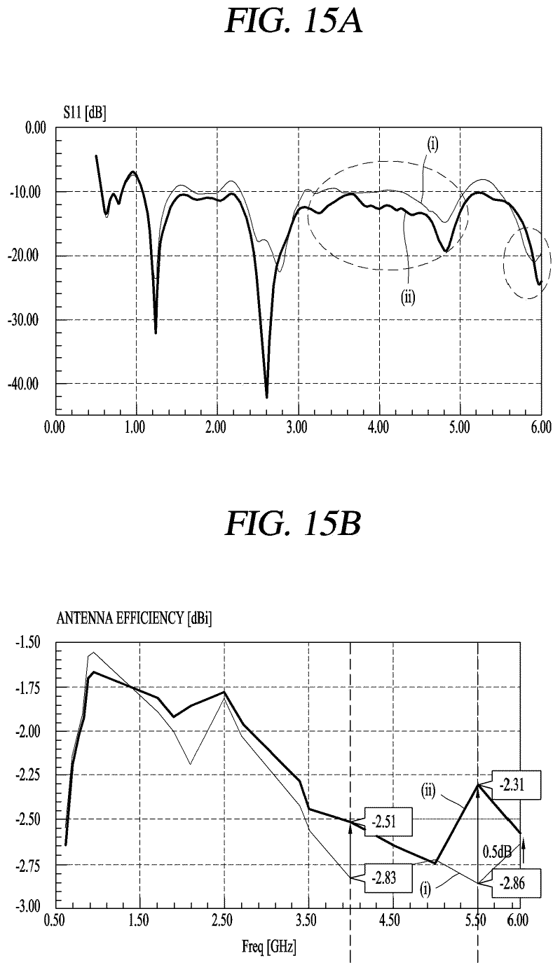

In relation to this, FIG. 15A shows comparison between reflection coefficient characteristics of the antenna assemblies of FIGS. 11A and 14C. FIG. 15B shows comparison between antenna efficiency characteristics of the antenna assemblies of FIGS. 11A and 14C.

Referring to FIG. 11A, as a step structure in a vertical direction is disposed along respective connection points in the first conductive pattern 1110 of the assembly 1000, a current component in a vertical direction may be increased. On the other hand, referring to FIG. 14C, as a continuous connection structure is disposed along respective connection points in the first conductive pattern 1110 of the antenna assembly 1000c, a current component in a vertical direction may be reduced. Referring to FIG. 15A, (i) a reflection coefficient of the antenna assembly 1000c having the continuous structure may deteriorate in a frequency band of about 3 GHz or higher, compared to (ii) a reflection coefficient of the antenna assembly 1000 having the step structure.

Referring to FIG. 11A, as the step structure in a vertical direction is disposed along respective connection points in the first conductive pattern 1110 of the antenna assembly 1000, a current component in a vertical direction may be increased. On the other hand, referring to FIG. 14C, as the continuous connection structure is disposed along respective connection points in the first conductive pattern 1110 of the antenna assembly 1000c, a current component in a vertical direction may be reduced. Referring to FIG. 15B, (i) an antenna efficiency of the antenna assembly 1000c having the continuous structure may deteriorate in a frequency band of about 1.5 GHz or higher, compared to (ii) an antenna efficiency of the antenna assembly 1000 having the step structure. Particularly, (i) an antenna efficiency of the antenna assembly 1000c having the continuous structure may deteriorate by 0.3 dB or more at about 4 GHZ, compared to (ii) an antenna efficiency of the antenna assembly 1000 having the step structure. (i) An antenna efficiency of the antenna assembly 1000c having the continuous structure may deteriorate by 0.5 dB or more at about 5.5 GHz compared to (ii) an antenna efficiency of the antenna assembly 1000 having the step structure.

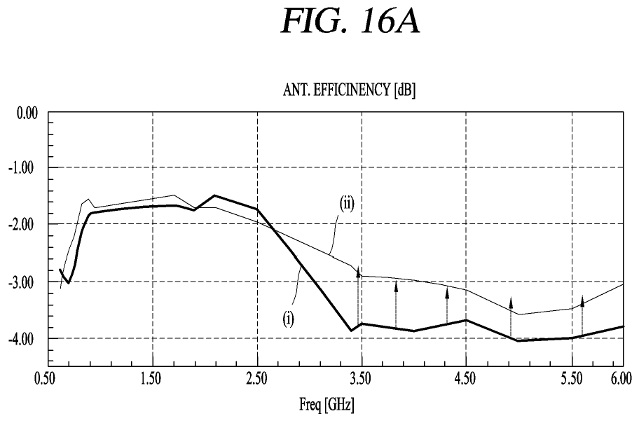

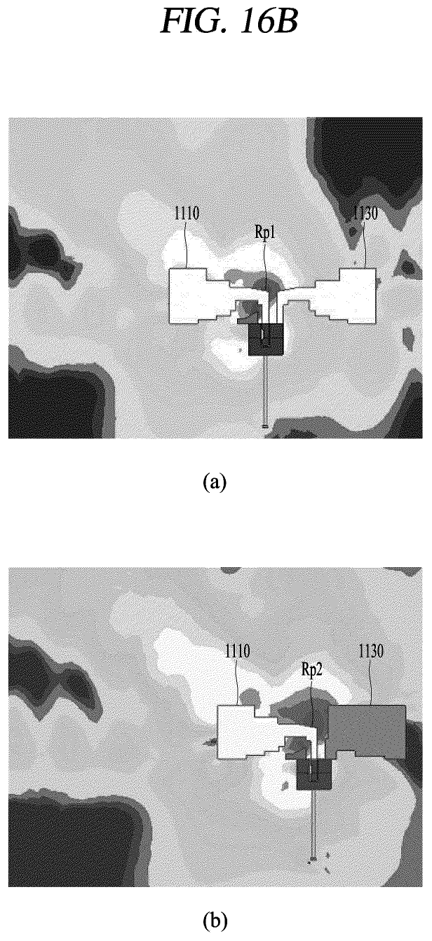

Hereinafter, comparison between electrical characteristics of the antenna assembly 1000b having a symmetrical structure of FIG. 14B and electrical characteristics of the antenna assembly 1000b having the asymmetrical structure of FIG. 11B is described. In relation to this, FIG. 16A shows antenna efficiencies of antenna assemblies having the asymmetrical structure and the symmetrical structure shown in FIG. 11B and FIG. 14B, respectively. FIG. 16B shows electric field distributions of the antenna assemblies having the asymmetrical structure and the symmetrical structure shown in FIG. 11B and FIG. 14B, respectively.

Referring to FIG. 14B and FIG. 16A, (i) an antenna efficiency of the antenna assembly 1000b having the symmetrical structure has a value of about −4 dBi in a frequency band of 3.5 GHz or higher. Referring to FIG. 11B and FIG. 16A, (ii) an antenna efficiency of the antenna assembly 1000 having the asymmetrical structure has a value of about −3 dBi to −3.5 dBi in a frequency band of 3.5 GHz or higher. Accordingly, the antenna efficiency of the antenna assembly 1000 having the asymmetrical structure of FIG. 11B has a value higher than that of the antenna assembly 1000b having the symmetrical structure of FIG. 12B by about 0.5 to 1.0 dB.

The antenna assembly 1000 having the asymmetrical structure has an antenna efficiency of a value higher than that of the antenna assembly 1000b having the symmetrical structure by about 0.5 to 1.0 dB in a frequency band of about 3 GHz or higher. Accordingly, an antenna efficiency of the antenna assembly 1000 having the asymmetrical structure may be enhanced in a frequency band of about 3 GHz or higher in the second frequency band and in the third frequency band.

(a) of FIG. 16B shows an electric field distribution of the antenna assembly 1000b having the symmetrical structure of FIG. 14B at 3.5 GHz. Meanwhile, (b) of FIG. 16B shows an electric field distribution of the antenna assembly 1000 having the asymmetric structure of FIG. 11B at 3.5 GHz. The third conductive pattern 1130 of the antenna assembly 1000 having the asymmetrical structure of FIG. 11B may be configured to have a size larger than that of the third conductive pattern 1130b of FIG. 14B. Accordingly, this corresponds to a case in which a ground size of a monopole antenna is increased due to the third conductive pattern 1130 of the antenna assembly 1000 having the asymmetrical structure, as the third conductive pattern 1130 is larger than the third conductive pattern 1130b. As a size of the third conductive pattern 1130 of the antenna assembly 1000 having the asymmetrical structure increases, electric field radiation in a monopole antenna mode increases in the second frequency band.

Referring to FIG. 14B and (a) of FIG. 16B, a peak area of the electric field distribution occurs in a first region R1p between the first conductive pattern 1100 and the third conductive pattern 1130 due to the third conductive pattern 1130 having a structure symmetrical to the first conductive pattern 1100. Referring to FIG. 11B and (b) of FIG. 16B, a peak area of the electric field distribution occurs in a second region R2p adjacent to the third conductive pattern 1130 further than the first region R1p due to the third conductive pattern 1130 which is larger than the first conductive pattern 1100. In addition, as a size of the third conductive pattern 1130 of the antenna assembly 1000 having the asymmetric structure is increased, an area of the second region R2p, i.e., the peak area of the electric field distribution also increases compared to an area of the first region Rp1. Accordingly, an antenna efficiency of the antenna assembly 1000 having an asymmetrical structure may be enhanced in a frequency band of about 3 GHz or higher and in the third frequency band.

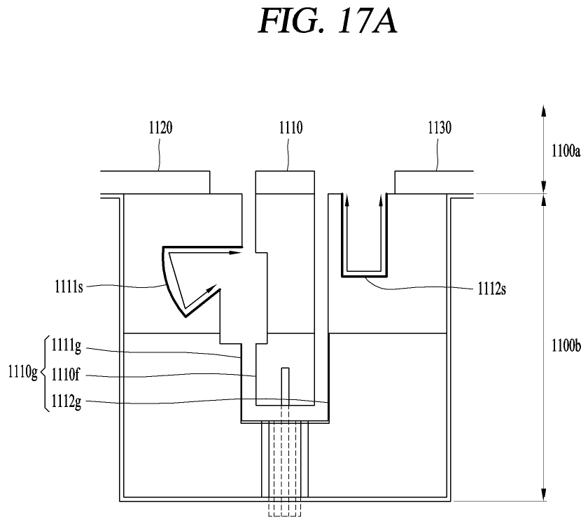

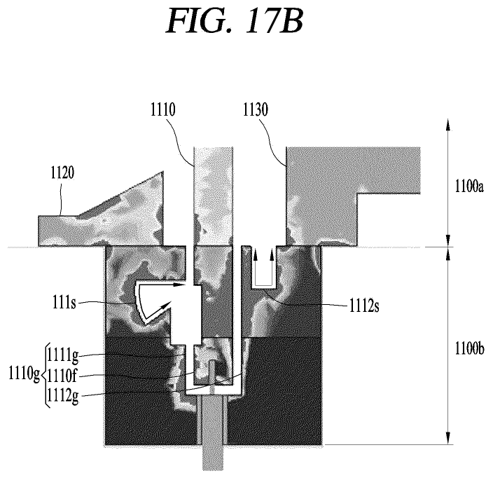

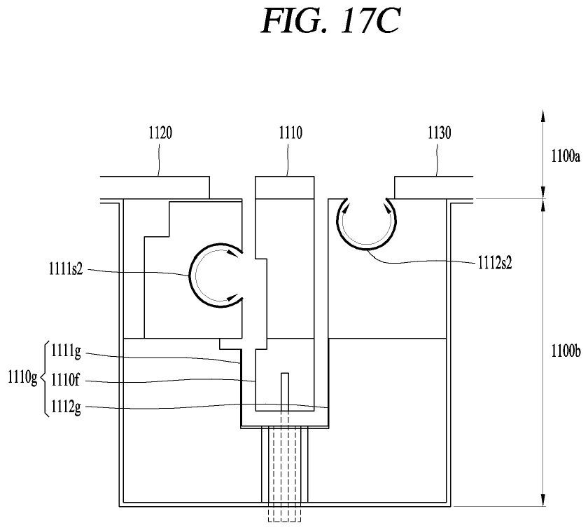

Meanwhile, the ground conductive pattern 1110g of the second region 1100b of the antenna assembly 1100 according to the present disclosure may include one or more slots for wideband impedance matching. In this regard, FIG. 17A illustrates first and second slot structures disposed in a ground conductive pattern of the antenna assembly according to the present disclosure. Meanwhile, FIG. 17B illustrates current distribution in the first and second slot structures disposed in the ground conductive pattern of the antenna assembly of FIG. 17A and in a periphery of the ground conductive pattern.

Referring to FIG. 17A, the ground conductive pattern 1110g may be configured to include a first slot 1111s and a second slot 1112s. The first portion 1111g of the ground conductive pattern 1110g may include the first slot 1111s. The first slot 1111s may be configured to have a length in a range from 2/2 to 2 with reference to about 5 GHz. An opened region of the first slot 1111s may be disposed to face the feed pattern 1110f. The second portion 1112g of the ground conductive pattern 1110g may include the second slot 1112s. The second slot 1112s may be configured to have a length in a range from 2/2 to 2 with reference to about 5 GHz. An opened region of the second slot 1112s may be disposed to face a first region 1110a which is a radiator region.

Referring to FIG. 17B, it may be understood that current distribution is concentrated on the feed pattern 1110f and a periphery of the first and second slots 1111s and 1112s disposed at both sides of the feed pattern 1110f. Accordingly, as impedance matching characteristics are improved in the HB band and the UHB band, i.e., in a band of 3.5 to 6 GHz, the antenna assembly may perform wideband operation.

Meanwhile, a slot structure of the antenna assembly according to the present disclosure is not limited to a rectangular slot. In relation to this, FIG. 17C illustrates a circular slot structure of the antenna assembly according to an embodiment. Referring to FIG. 17C, a first slot 1111s2 and a second slot 1112s2 having a circular shape may be disposed in the first portion 1111g and the second portion 1112g of the ground conductive pattern 1110g, respectively. In this regard, the first and second slots 1111s1 and 1112s2 are not limited to a circular shape, and may be implemented to have an elliptical shape or any polygonal shape. Referring to FIGS. 17A and 17C, one of the first slots 1111s and 1111s2 may be disposed in the first portion 1111g of the ground conductive pattern 1110g. In addition, one of the second slots 1112s and 1112s2 may be disposed in the second portion 1111g of the ground conductive pattern 1110g.

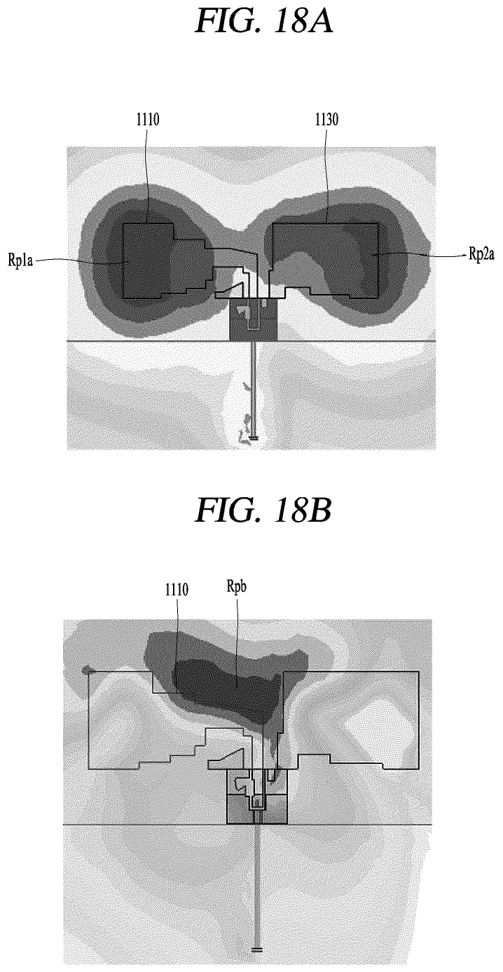

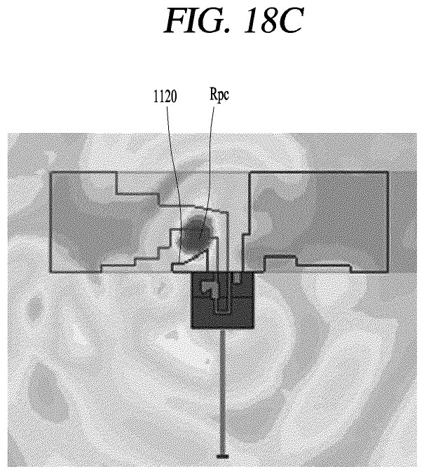

The antenna assembly according to the present disclosure may operate as a broadband antenna by differently configuring conductive patterns that operate as radiators according to a plurality of antenna operating modes. In this regard, FIGS. 18A to 18C are views illustrating electric field distributions defined on conductive patterns of the antenna assembly in first to third frequency bands.

Referring to FIGS. 13A and 18A, the current distribution on the first and third conductive patterns 1110 and 1130 of the antenna assembly 1000 in the first frequency band may be shown to be higher than the current distribution on other regions. A first region Rp1a that is a peak region of the current distribution may be disposed in one region of the first conductive pattern 1110. A second region Rp2a that is a peak region of the current distribution may be disposed in one region of the third conductive pattern 1130. Accordingly, the first conductive pattern 1110 and the third conductive pattern 1130 may operate as radiators in the first frequency band.

The third frequency band may be set to 617 to 960 MHz, but is not limited thereto. The first and third conductive patterns 1110 and 1130 may operate as dipole antennas in the first frequency band. The first and third conductive patterns 1110 and 1130 may operate in a dipole antenna mode to define a radiation pattern in a vertical direction, as illustrated in (b) of FIG. 12A.

Referring to FIGS. 13B and 18B, the current distribution on the first conductive pattern 1110 of the antenna assembly 1000 in the second frequency band may be shown to be higher than the current distribution on other regions. A peak region Rpb of the current distribution may be disposed in the boundary region of the first conductive pattern 1110. Also, the first conductive pattern 1110 may operate as a radiator in the second frequency band.

The second frequency band may be set to 1520 to 4500 MHz, but is not limited thereto. Therefore, the first conductive pattern 1110 may operate as a monopole antenna in the second frequency band. The first conductive pattern 1110 may operate in a monopole antenna mode to define a radiation pattern in a lateral direction, as illustrated in (a) of FIG. 12A.

Referring to FIGS. 13C and 18C, the current distribution on the second conductive pattern 1120 of the antenna assembly 1000 in the third frequency band may be shown to be higher than the current distribution on other regions. A peak region Rpb of the current distribution may be disposed in the boundary region of the second conductive pattern 1120. Also, the second conductive pattern 1120 may operate as a radiator in the third frequency band. The third frequency band may be set to 4500 to 6000 MHz, but is not limited thereto. Therefore, the second conductive pattern 1120 may operate as a monopole antenna in the third frequency band. The second conductive pattern 1120 may operate in the monopole antenna mode to define a radiation pattern in a lateral direction, as illustrated in (a) of FIG. 12A.

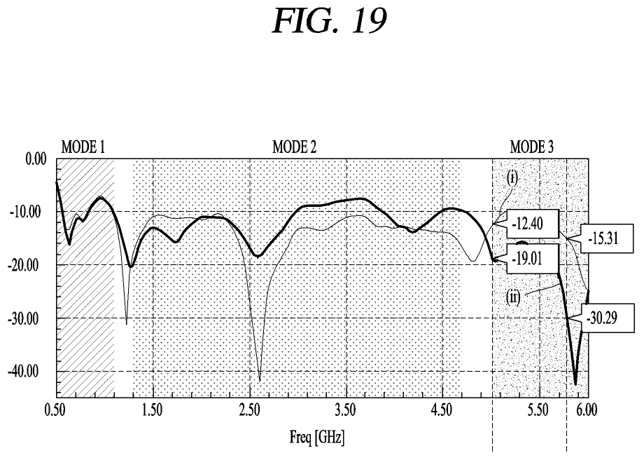

Meanwhile, an antenna assembly operating in a plurality of operating modes according to the present disclosure may operate as a radiator in a plurality of frequency bands. In relation to this, FIG. 19 shows reflection coefficient characteristics according to presence or absence of a slot for impedance matching in a CPW antenna structure according to the present disclosure.

(i) of FIG. 19 indicates a reflection coefficient of a first structure in which slots for impedance matching are not disposed in a feed region of the CPW antenna structure. (ii) of FIG. 19 indicates a reflection coefficient of a second structure in which slots for impedance matching are disposed in the feed region of the CPW antenna structure. (ii) of FIG. 19 indicates a reflection coefficient of the second structure in which the first slot 1111s and the second slot 1112s2 each shown in FIG. 17A for impedance matching are disposed in the feed region of the CPW antenna structure. Referring to FIG. 19, a reflection coefficient of the first structure in which slots are not disposed has a value of −12.4 to −15.3 dB in the third frequency band. A reflection coefficient of the second structure in which the first slot 1111s and the second slot 1112s2 are disposed has a value of −19 to −30.3 dB in the third frequency band. Accordingly, it may be understood that impedance matching characteristics are improved in the third frequency band as slots for impedance matching are disposed in the feed region of the CPW antenna structure.

Referring to FIG. 13A and FIG. 19, in the first frequency band, the antenna assembly 1000 operates as a radiator in a first operation mode. A reflection coefficient has a value of about −10 dB or less in the first frequency band of 617 to 960 MHz. Referring to FIG. 13B and FIG. 19, in the second frequency band, the antenna assembly 1000 operates as a radiator in a second operating mode. In the second frequency band of 1520 to 4500 MHz, a reflection coefficient has a value of about −10 dB or less. Referring to FIG. 13C and FIG. 19, in the third frequency band, the antenna assembly 1000 operates as a radiator in a third operating mode. In the third frequency band of 4500 to 6000 MHz, a reflection coefficient has a value of about −10 dB or less.

As the first and second slots 1111s and 1112s of FIG. 17A are added, a value of a reflection coefficient may be improved in a band of about 5 GHz. In this regard, it may be understood that a reflection coefficient is significantly improved at 5 GHz and 6 GHz as the first and second slots 1111s and 1112s are added. In addition, as the first and second slots 1111s and 1112s are added, a reflection coefficient has a value of about −15 dB or less at a frequency between 5 GHz and 6 GHz.

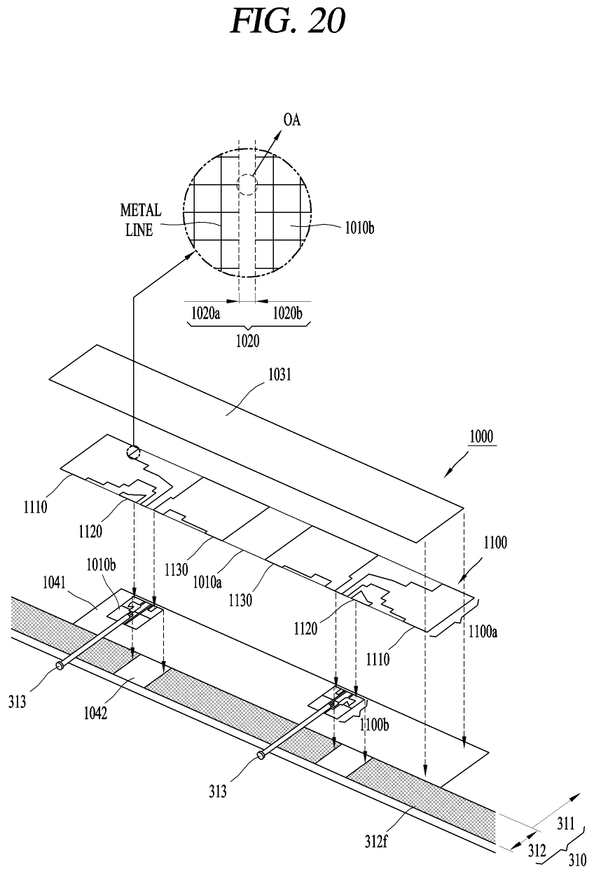

The antenna assembly according to one aspect of the present disclosure has been described. Hereinafter, an antenna assembly including a plurality of dielectric substrates according to another aspect of the present disclosure is described. In relation to this, FIG. 20 illustrates a structure in which first and second dielectric substrates of the antenna assembly according to an embodiment are combined.

Referring to FIG. 20, the antenna assembly 1000 may include the first dielectric substrate 1010a which is a transparent substrate and the second dielectric substrate 1010b which is an opaque substrate. The antenna assembly 1000 may include the first region 1100a corresponding to a radiator region and second region 1100b corresponding to a feed region. The antenna assembly 1000 may further include the protective layer 1031 and adhesive layers 1041 and 1042. The antenna module 1100 implemented as one or more transparent antenna elements may be placed in the first region 1100a. A feeding structure implemented as one or more second dielectric substrates 1010b may be placed in the second region 1100b.

A glass panel 310 to which the antenna assembly 1000 may be attached may include the transparent region 311 and the opaque region 312. The first dielectric substrate 1010a having a transparent antenna element disposed thereon may be attached to the transparent region 311 of the glass panel 310 through the adhesive layer 1041. The protective layer 1031 may be disposed in a region above the first dielectric substrate 1010a.

A frit layer 312f having the frit pattern of FIG. 6A thereon may be disposed in the opaque region 312 of the glass panel 310. The frit pattern may be removed from a region in which the second dielectric substrate 1010b is disposed, among the frit layer 312f of the opaque region 312. The second dielectric substrate 1010b may be placed in the opaque region 312 from which the frit pattern has been removed. The adhesive layer 1042 may be disposed in the opaque region 312 from which the frit pattern has been removed, and the second dielectric substrate 1010b may be attached to the opaque region 312 of the glass panel 310 through the adhesive layer 1042.

Referring to FIGS. 9A to 9C, FIG. 11B, FIG. 17A, and FIG. 20, the antenna assembly 1000 including a plurality of dielectric substrates is described. The antenna assembly 1000 may be configured to include the first dielectric substrate 1010a, the first region 1100a, the second dielectric substrate 1010b, and the second region 1100b. The first region 1100a may include conductive patterns on one side surface of the first dielectric substrate 1010a and may be configured to radiate a wireless signal. The second region 1100b may be configured to include the ground conductive pattern 1110g and the feed pattern 1110f each on one side surface of the second dielectric substrate 1010b. The first region 1100a and the second region 1100b may also be referred to as a radiator region and a ground region (or a feed region), respectively.

A plurality of conductive patterns disposed in the first region 1100a of the antenna assembly 1000 may be implemented as two or more conductive patterns and configured to operate in a plurality of frequency bands. Referring to FIG. 17, the plurality of conductive patterns may be configured to include the first conductive pattern 1110, the second conductive pattern 1120, and the third conductive pattern 1130.

The first conductive pattern 1110 may include a plurality of sub patterns, namely, a plurality of conductive portions. The first conductive pattern 1110 may be configured to include the first portion 1111 and the second portion 1112. The first portion 1111 may be disposed perpendicularly to the second portion 1112. The second portion 1112 may be electrically connected to the feed pattern 1110f. In this regard, the meaning of “electrically connected” may include that the respective conductive portions are connected either directly connected or by being spaced apart at a certain gap.

The second conductive pattern 1120 may be disposed in one side region or a lower region of the first conductive pattern 1110. The second conductive pattern 1120 may be electrically connected to a first portion 1111g of the ground conductive pattern 1110g. The second conductive pattern 1120 may further be arranged on the antenna assembly 1000 to resonate further in a frequency band different from operating frequency bands of the first conductive pattern 1110 and the third conductive pattern 1130.

The third conductive pattern 1130 may be disposed in another side region of the first conductive pattern 1110. The third conductive pattern 1130 may be electrically connected to a second portion 1112g of the ground conductive pattern 1110g. The third conductive pattern 1130 may further be arranged on the antenna assembly 1000 to further resonate in a frequency band different from operating frequency bands of the first conductive pattern 1110 and the second conductive pattern 1120.

The second conductive pattern 1120 may be configured to have a size smaller than that of the third conductive pattern 1130. Accordingly, the antenna assembly 1000 may operate as a radiator in a higher frequency band due to the second conductive pattern 1120. The second conductive pattern 1120 may be arranged between the first portion 1111 of the first conductive pattern 1110 and the second portion 1112 of the first conductive pattern 1110. Accordingly, the second conductive pattern 1120 may be arranged in a region below the first conductive pattern 1110, and a size of the antenna assembly 1000 may be reduced compared to when the second conductive pattern 1120 is arranged in a region at one side of the first conductive pattern 1110. The first portion 1111 of the first conductive pattern 1110 and the third conductive pattern 1130 may be placed at opposite sides with reference to the second portion 1112 of the first conductive pattern 1110. The first portion 1111 of the first conductive pattern 1110 and the third conductive pattern 1130 may be placed on one side region and another side region with reference to the second portion 1112 of the first conductive pattern 1110.

The first conductive pattern 1110 is combined with the third conductive pattern 1130 to operate in the monopole antenna mode in the first frequency band, and operates separately in the dipole antenna mode in the second frequency band. To do so, a shape of the first conductive pattern 1110 may be configured to have a step structure to be optimized for wideband operation. In this regard, the first conductive pattern 1110 may be configured to have a plurality of boundary sides.

Referring to FIGS. 11A, 11B, and 13A to 13C, the first portion 1111 of the first conductive pattern 1110 may be configured to have a plurality of boundary sides. The first portion 1111 of the first conductive pattern 1110 may be configured to have the first boundary side BS1 to the fourth boundary side BS4.

The first boundary side BS1 of the first portion 1111 of the first conductive pattern 1110 may be configured to have a first step structure. The second boundary side BS2 of the first portion 1111 of the first conductive pattern 1110 may be configured to have a second step structure. The second step structure may be configured to have a shape different from that of the first step structure.

The third boundary side BS3 of the first portion 1111 of the first conductive pattern 1110 may be arranged between a first end portion of the first boundary side BS1 of the first portion 1111 of the first conductive pattern 1110 and a first end portion of the second boundary side BS2 of the first portion 1111 of the first conductive pattern 1110. The fourth boundary side BS4 of the first portion 1111 of the first conductive pattern 1110 may be arranged between a second end portion of the first boundary side BS1 of the first portion 1111 of the first conductive pattern 1110 and a second end portion of the second boundary side BS2 of the first portion 1111 of the first conductive pattern 1110. Accordingly, a shape of the first portion 1111 of the first conductive pattern 1110 may be optimized for wideband operation in the first and second frequency bands.

The second conductive pattern 1120 may also be configured to have the first and second boundary sides BS1 and BS2. A part of the first boundary side BS1 of the first portion 1111 of the first conductive pattern 1110 may be disposed to face the first boundary side BS1 of the second conductive pattern 1120. A part of the first boundary side BS1 of the first portion 1111 of the first conductive pattern 1110 may be disposed to face the second boundary side BS2 of the second conductive pattern 1120.

The third conductive pattern 1130 may also be configured to have a plurality of boundary sides to have a step structure. The third conductive pattern 1130 may be configured to have the first boundary side BS1 to the fourth boundary side BS4. The first boundary side BS1 of the third conductive pattern 1130 may be configured to have a third step structure. A first end portion of the first boundary side BS1 of the third conductive pattern 1130 may be connected to the second portion 1112g of the ground conductive pattern 1110g. The second boundary side BS2 of the third conductive pattern 1130 may be placed at a side opposite to the first boundary side BS1 of the third conductive pattern 1130.

The third boundary side BS3 of the third conductive pattern 1130 may be arranged between the first end portion of the first boundary side BS1 of the first conductive pattern and a first end portion of the second boundary side BS2 of the third conductive pattern 1130. The fourth boundary side BS4 of the third conductive pattern 1130 may be arranged between a second end portion of the first boundary side BS1 of the third conductive pattern 1130 and a second end portion of the second boundary side BS2 of the third conductive pattern 1130. The third boundary side BS3 of the third conductive pattern 1130 may be placed at a side opposite to the fourth boundary side BS4 of the third conductive pattern 1130. A part of the second part 1112 of the first conductive pattern 1110 may be disposed to face the fourth boundary side BS4 of the third conductive pattern 1130.

A length of the third boundary side BS3 of the third conductive pattern 1130 may be configured to be identical to a length of the third boundary side BS3 of the first conductive pattern 1110. Accordingly, the antenna assembly 1000 may be implemented to have a length of the third boundary side BS3 of the first and third conductive patterns 1110 and 1130, and a size of a whole antenna may be minimized Meanwhile, the ground conductive pattern 1110g of the second region 1100b of the antenna assembly 1100 according to the present disclosure may include one or more slots for wideband impedance matching. As described above, FIGS. 17A and 17B illustrate current distribution in first and second slot structures disposed in a ground conductive pattern of the antenna assembly according to the present disclosure and in a periphery of the ground conductive pattern.

Referring to FIG. 17A, the ground conductive pattern 1110g may be configured to include the first slot 1111s and the second slot 1112s. The first portion 1111g of the ground conductive pattern 1110g may include the first slot 1111s. The first slot 1111s may be configured to have a length in a range from 2/2 to 2 with reference to about 5 GHz. An opened region of the first slot 1111s may be disposed to face the feed pattern 1110f. The second portion 1112g of the ground conductive pattern 1110g may include the second slot 1112s. The second slot 1112s may be configured to have a length in a range from 2/2 to 2 with reference to about 5 GHz. An opened region of the second slot 1112s may be disposed to face the first region 1110a which is a radiator region.

Meanwhile, the antenna assembly according to the present disclosure may be configured to have a transparent antenna structure. In this regard, referring to FIG. 7B, FIG. 11A, and FIG. 20, the first conductive pattern 1110 and the third conductive pattern 1130 of the antenna assembly 1000 may be disposed on the dielectric substrate 1010a to have the metal mesh shape 1020 including the plurality of opened regions OA. The first conductive pattern 1110 and the third conductive pattern 1130 may include the metal grid patterns 1020a. The metal grid patterns 1020a may be configured to have the dummy metal grid patterns 1020b and the opened regions OA. The first conductive pattern 1110 and the third conductive pattern 1130 may be configured to have a CPW structure on the dielectric substrate 1010a.

Referring to FIGS. 7B, 11B, and 20, the first conductive pattern 1110, the second conductive pattern 1120, and the third conductive pattern 1130 may be configured to have the metal mesh shape 1020 including the plurality of opened regions OA disposed on the dielectric substrate 1010. The first conductive pattern 1110, the second conductive pattern 1120, and the third conductive pattern 1130 may be implemented as a CPW structure on the dielectric substrate 1010. The first conductive pattern 1110, and the second conducive pattern 1120, and the third conductive pattern 1130 may be configured to have the metal grid patterns 1020a. The metal grid patterns 1020a may be configured to have the dummy metal grid patterns 1020b and the opened regions OA. The first conductive pattern 1110, the second conductive pattern 1120, and the third conductive pattern 1130 may be configured as a CPW structure on the dielectric substrate 1010a.

The antenna assembly 1000 may include the plurality of dummy mesh grid patterns 1020b in a radiator region on the dielectric substrate 1010a, i.e., an outside portion of the first region 1100a. Meanwhile, the plurality of dummy mesh grid patterns 1020b may also be placed in dielectric regions between the first to third conductive patterns 1110 to 1130. The plurality of dummy metal grid patterns 1020b may be disposed not to be connected to the feed pattern 1110f and the ground region 1110g. The plurality of dummy mesh grid patterns 1020b may be disposed to be separate from each other.

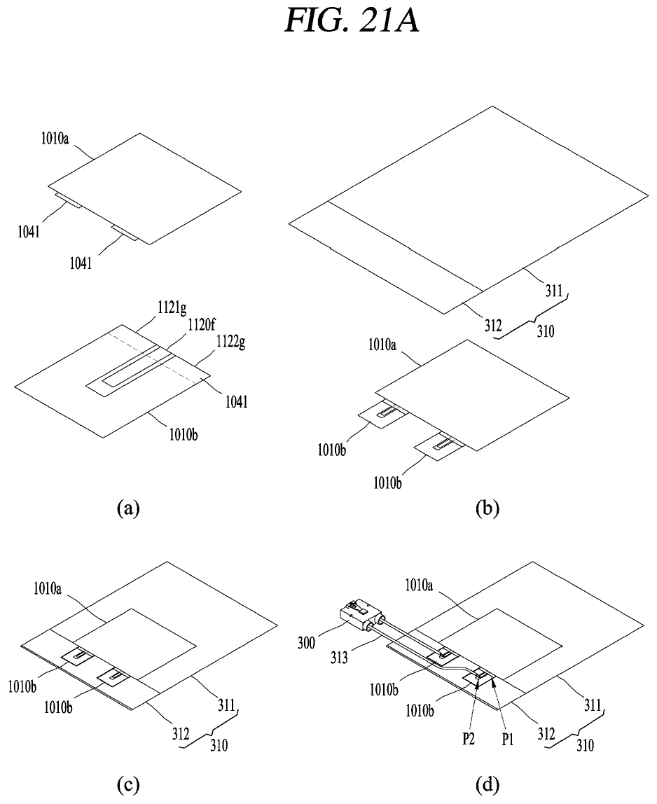

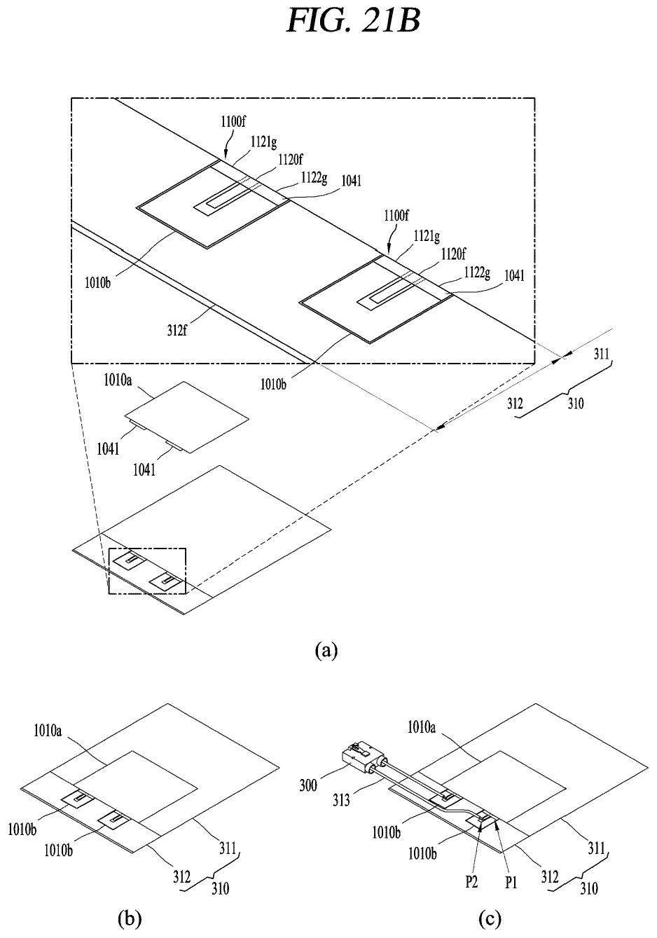

Meanwhile, an antenna assembly according to the present disclosure may be configured to include a first transparent dielectric substrate, on which a transparent electrode layer is disposed, and a second dielectric substrate. In this regard, FIGS. 21A and 21B illustrate a flow of processes in which the antenna assembly according to embodiments is manufactured by being coupled to a glass panel.

Referring to (a) of FIG. 21A, the first transparent dielectric substrate 1000a on which the transparent electrode layer is disposed may be manufactured. In addition, the second dielectric substrate 1000b that includes the feed pattern 1120f and the ground patterns 1121g and 1122g disposed on both sides of the feed pattern 1120f may be manufactured. The second dielectric substrate 1000b may be implemented as an FPCB, but is not limited thereto. Adhesion regions corresponding to the adhesive layers 1041 may be disposed on the first transparent dielectric substrate 1000a and the second dielectric substrate 1000b, respectively.

Referring to (b) of FIG. 21A, the glass panel 310 with the transparent region 311 and the opaque region 312 may be manufactured. In addition, the antenna assembly 1000 may be manufactured by coupling at least one second dielectric substrate 1000b to the lower region of the first transparent dielectric substrate 1000a. The first transparent dielectric substrate 1000a and the second dielectric substrate 1000b may be coupled through ACF bonding or low-temperature soldering to be implemented as the transparent antenna assembly. Through this, the first conductive pattern disposed on the first transparent dielectric substrate 1000a may be electrically connected to the second conductive pattern disposed on the second dielectric substrate 1000b. When a plurality of antenna elements are implemented on the glass panel 310, the feeding structure 1100f made of the second dielectric substrate 1000b may also be implemented as a plurality of feeding structures.

Referring to (c) of FIG. 21A, the transparent antenna assembly 1000 may be attached to the glass panel 310. In this regard, the first transparent dielectric substrate 1000a on which the transparent electrode layer is disposed may be disposed in the transparent region 311 of the glass panel 310. Meanwhile, the second dielectric substrate 1000b, which is the opaque substrate, may be disposed in the opaque region 312 of the glass panel 310.

Referring to (d) of FIG. 21A, the first transparent dielectric substrate 1000a and the second dielectric substrate 1000b may be bonded at a first position P1. The connector part 313 such as a Fakra cable may be bonded to the second dielectric substrate 1000b at a second position P2. The transparent antenna assembly 1000 may be coupled to the telematics control unit (TCU) 300 through the connector part 313. To do so, the second conductive pattern disposed on the second dielectric substrate 1010b may be electrically connected to a connector of one end of the connector part 313. A connector of another end of the connector part 313 may be electrically connected to the telematics control unit (TCU) 300.

The antenna assembly of FIG. 21B has a structural difference, compared to the antenna assembly of FIG. 21a, in that the opaque substrate is not manufactured separately but is manufactured integrally with the glass panel 310. The antenna assembly of FIG. 21B is implemented in such a way that the feeding structure implemented as the opaque substrate is directly printed on the glass panel 310 rather than being separately manufactured as an FPCB.

Referring to (a) of FIG. 21B, the first transparent dielectric substrate 1000a on which the transparent electrode layer is disposed may be manufactured. In addition, the glass panel 310 with the transparent region 311 and the opaque region 312 may be manufactured. In the process of manufacturing of the glass panel of the vehicle, metal wires/pads for connection of the connectors may be implemented (fired). Like heating wires implemented on the vehicle glass, a transparent antenna mounting portion may be implemented in a metal form on the glass panel 310. In this regard, a second conductive pattern may be implemented on the region where the adhesive layer 1041 is disposed for electrical connection to the first conductive pattern of the first transparent dielectric substrate 1000a.

In this regard, the second dielectric substrate 1000b on which the second conductive pattern is disposed may be manufactured integrally with the glass panel 310. The second dielectric substrate 1000b may be disposed integrally with the glass panel 310 on the opaque region 312 of the glass panel 310. The frit pattern 312 may be removed from the opaque region 312 where the second dielectric substrate 1000b is disposed. The second conductive pattern may be implemented by forming the feed pattern 1120f and the ground patterns 1121g and 1122g on both sides of the feed pattern 1120f on the second dielectric substrate 1000b.

Referring to (b) of FIG. 21B, the transparent antenna assembly 1000 may be attached to the glass panel 310. In this regard, the first transparent dielectric substrate 1000a on which the transparent electrode layer is disposed may be disposed in the transparent region 311 of the glass panel 310. The antenna assembly 1000 may be manufactured by coupling at least one second dielectric substrate 1000b to the lower region of the first transparent dielectric substrate 1000a. The first transparent dielectric substrate 1000a and the second dielectric substrate 1000b may be coupled through ACF bonding or low-temperature soldering to be implemented as the transparent antenna assembly. By doing so, the first conductive pattern disposed on the first transparent dielectric substrate 1000a may be electrically connected to the second conductive pattern disposed on the second dielectric substrate 1000b. When a plurality of antenna elements are implemented on the glass panel 310, the feeding structure 1100f made of the second dielectric substrate 1000b may also be implemented as a plurality of feeding structures.

Referring to (c) of FIG. 21B, the first transparent dielectric substrate 1000a and the second dielectric substrate 1000b may be bonded at a first position P1. The connector part 313, such as a Fakra cable, may be bonded to the second dielectric substrate 1000b at a second position P2. The transparent antenna assembly 1000 may be coupled to the telematics control unit (TCU) 300 through the connector part 313. To do so, the second conductive pattern disposed on the second dielectric substrate 1010b may be electrically connected to a connector of one end of the connector part 313. A connector of another end of the connector part 313 may be electrically connected to the telematics control unit (TCU) 300.

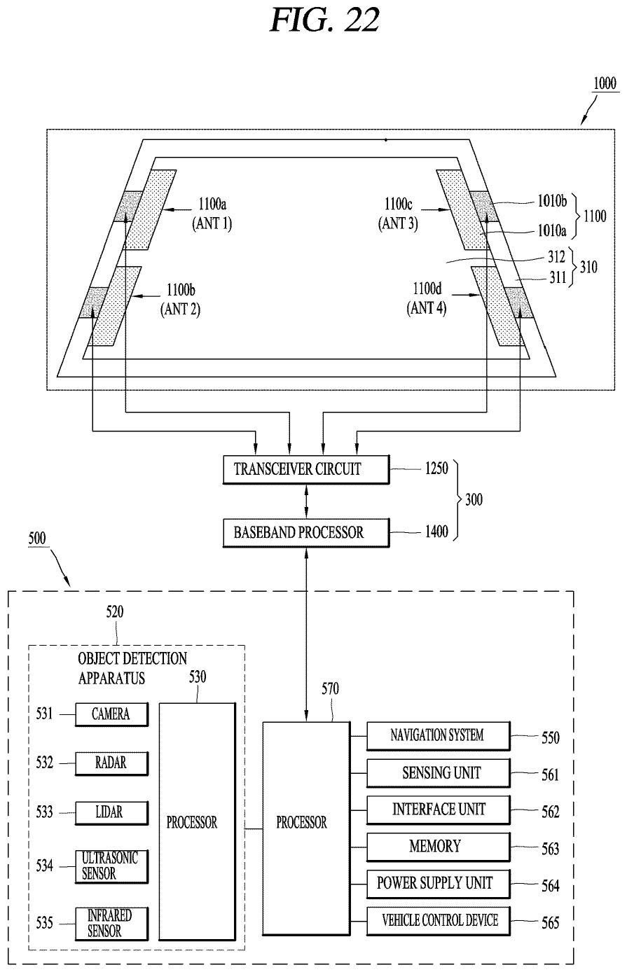

Hereinafter, a vehicle having an antenna module according to one example will be described in detail. FIG. 22 illustrates an example of a configuration in which a plurality of antenna modules disposed at different positions in a vehicle according to the present disclosure are coupled to other components of the vehicle.

Referring to FIGS. 1 to 22, the vehicle 500 may include a conductive vehicle body operating as an electrical ground. The vehicle 500 may include the plurality of antennas 1100a to 1100d that may be disposed at different positions on the glass panel 310. The antenna assembly 1000 may be configured such that the plurality of antennas 1100a to 1100d include a communication module 300. The communication module 300 may include a transceiver circuit 1250 and a processor 1400. The communication module 300 may correspond to the TCU of the vehicle or may constitute at least a portion of the TCU.

The vehicle 500 may include an object detecting apparatus 520 and a navigation system 550. The vehicle 500 may further include a separate processor 570 in addition to the processor 1400 included in the communication module 300. The processor 1400 and the separate processor 570 may be physically or functionally separated and implemented on one substrate. The processor 1400 may be implemented as a TCU, and the processor 570 may be implemented as an electronic control unit (ECU).

In case where the vehicle 500 is an autonomous vehicle, the processor 570 may be an autonomous driving control unit (ADCU) integrated with an ECU. Based on information detected through the camera 531, radar 532, and/or lidar 533, the processor 570 may search for a path and control the speed of the vehicle 500 to accelerate or decelerate. To this end, the processor 570 may interoperate with the processor 530 corresponding to the MCU in the object detecting apparatus 520 and/or the communication module 300 corresponding to the TCU.

The vehicle 500 may include the first transparent dielectric substrate 1010a and the second dielectric substrate 1010b disposed on the glass panel 310. The first transparent dielectric substrate 1010a may be disposed inside the glass panel 310 of the vehicle or may be attached to the surface of the glass panel 310. The first transparent dielectric substrate 1010a may be configured such that conductive patterns in the metal mesh grid shape are disposed. The vehicle 500 may include an antenna module 1100 that is configured in a metal mesh shape on one side surface of the dielectric substrate 1010 to radiate wireless signals.

The antenna assembly 1000 may include a first antenna module 1100a to a fourth antenna module 1100d to perform MIMO. The first antenna module 1100a, the second antenna module 1100b, the third antenna module 1100c, and the fourth antenna module 1100d may be disposed on the upper left, lower left, upper right, and lower right sides of the glass panel 310, respectively. The first antenna module 1100a to the fourth antenna module 1100d may be referred to as a first antenna ANT1 to a fourth antenna ANT4, respectively. The first antenna ANT1 to the fourth antenna ANT4 may be referred to as the first antenna module ANT1 to the fourth antenna module ANT4, respectively.

As described above, the vehicle 500 may include the telematics control unit (TCU) 300, which is the communication module. The TCU 300 may control signals to be received and transmitted through at least one of the first to fourth antenna modules 1100a to 1100d. The TCU 300 may include a transceiver circuit 1250 and a processor 1400.

Accordingly, the vehicle may further include a transceiver circuit 1250 and a processor 1400. A portion of the transceiver circuit 1250 may be disposed in units of antenna modules or in combination thereof. The transceiver circuit 1250 may control a radio signal of at least one of the first to third frequency bands to be radiated through the antenna modules ANT1 to ANT4. The first to third frequency bands may be the low band (LB), the mid band (MB), and the high band (HB) for 4G/5G wireless communications, but are not limited thereto.

The processor 1400 may be operably coupled to the transceiver circuit 1250 and may be configured as a modem operating in a baseband. The processor 1400 may receive or transmit a signal through at least one of the first antenna module ANT1 and the second antenna module ANT2. The processor 1400 may perform a diversity operation or MIMO using the first antenna module ANT1 and the second antenna module ANT2 such that a signal is transmitted to the inside of the vehicle.

Antenna modules may be disposed in different regions of one side surface and another side surface of the glass panel 310. The antenna modules may perform MIMO by simultaneously receiving signals from the front of the vehicle. In this regard, to perform 4×4 MIMO, the antenna modules may further include a third antenna module ANT3 and a fourth antenna module ANT4 in addition to the first antenna module ANT1 and the second antenna module ANT2.

The processor 1400 may select an antenna module to perform communication with an entity communicating with the vehicle based on a driving path of the vehicle and a communication path with the entity. The processor 1400 may perform MIMO by using the first antenna module ANT1 and the second antenna module ANT2 based on a direction that the vehicle travels. Alternatively, the processor 1400 may perform MIMO through the third antenna module ANT2 and the fourth antenna module ANT4 based on the direction that the vehicle travels.

The processor 1400 may perform MIMO in the first band through at least two of the first antenna ANT1 to the fourth antenna ANT4. The processor 1400 may perform MIMO in at least one of the second band and the third band through at least two of the first antenna ANT1 to the fourth antenna ANT4.

Accordingly, when signal transmission/reception performance of the vehicle in any one band deteriorates, signal transmission/reception in the vehicle may be performed in other bands. For example, the vehicle may preferentially perform communication connection in the first band, which is the low band, for wide communication coverage and connection reliability, and then perform communication connection in the second and third bands.

The processor 1400 may control the transceiver circuit 1250 to perform the CA or DC through at least one of the first antenna ANT1 to the fourth antenna ANT4. In this regard, communication capacity may be expanded through the aggregation of the second band and the third band, which are wider than the first band. In addition, communication reliability may be improved through the dual connectivity with neighboring vehicles or entities by using the plurality of antenna elements disposed at the different regions of the vehicle.

The foregoing description has been given of a broadband transparent antenna assembly that may be placed on vehicle glass and a vehicle including the same. Hereinafter, technical effects of a broadband transparent antenna assembly capable of being disposed on glass of a vehicle and the vehicle are described.

According to the present disclosure, a wideband transparent antenna assembly capable of being disposed on vehicle glass and having a plurality of conductive patterns may be provided to allow 4G/5G wideband wireless communication in a vehicle.

According to the present disclosure, shapes of conductive patterns may be optimized in a wideband transparent antenna assembly capable of being disposed on vehicle glass, and antenna efficiency may be enhanced through an asymmetrical conductive pattern structure.

According to the present disclosure, an end portion of a conductive pattern of a transparent dielectric substrate may be connected to an end portion of a conductive pattern of an opaque substrate to overlap each other to be capable of reducing a feeding loss.

According to the present disclosure, a wideband antenna structure made of a transparent material and capable of enhancing antenna efficiency may be implemented by setting an antenna operation mode differently according to respective frequency bands while reducing a feeding loss.

According to the present disclosure, efficiency of a feeding structure of a wideband transparent antenna assembly may be enhanced by coupling a feed pattern of a feeding structure implemented as an opaque substrate disposed in an opaque region of vehicle glass directly to a transparent antenna.

According to the present disclosure, reliability of a mechanical structure including a feeding structure may be ensured through low-temperature bonding of a feed pattern of the feeding structure to a conductive pattern of an antenna module.

According to the present disclosure, an open dummy region in which slits are disposed in a dielectric region may be configured to minimize a difference in visibility between a region in which an antenna having a transparent material is disposed and other regions.

According to the present disclosure, as a boundary of an antenna region is apart from a boundary of a dummy pattern region by a predetermined space, invisibility of a transparent antenna and an antenna assembly including the transparent antenna may be ensured without deterioration of antenna performance.

According to the present disclosure, an open dummy structure may be configured such that intersections of metal lines in a dummy region or respective one points of the metal lines are disconnected to thereby ensure invisibility of a transparent antenna and an antenna assembly including the transparent antenna without deterioration of antenna performance.

According to the present disclosure, visibility may be enhanced in a transparent antenna without deterioration of antenna performance through an optimal design of slits in a dummy pattern having an opened region and via an opened region toward a radiator region.

According to the present disclosure, a broadband antenna structure made of a transparent material and capable of reducing a feeding loss and enhancing antenna efficiency while operating in a wide band may be provided through vehicle glass or a display area of an electronic device.

According to the present disclosure, a transparent antenna structure capable of performing wireless communication in 4G and 5G frequency bands may be provided, while minimizing a change in antenna performance and a difference in transparency between an antenna region and a peripheral region.

According to the present disclosure, a transparent antenna structure capable of performing wireless communication in mmWave frequency bands may be provided, while minimizing a change in antenna performance and a difference in transparency between an antenna region and a peripheral region.

Further scope of applicability of the present disclosure will become apparent from the following detailed description. It should be understood, however, that the detailed description and specific examples, such as the preferred embodiment of the disclosure, are given by way of illustration only, since various changes and modifications within the spirit and scope of the disclosure will be apparent to those skilled in the art.

In relation to the aforementioned present disclosure, design and driving of an antenna assembly having transparent antennas and a vehicle configured to control the antenna assembly may be implemented as computer-readable codes in a program-recorded medium. The computer-readable medium may include all types of recording devices each storing data readable by a computer system. Examples of such computer-readable media may include hard disk drive (HDD), solid state disk (SSD), silicon disk drive (SDD), ROM, RAM, CD-ROM, magnetic tape, floppy disk, optical data storage element and the like. Also, the computer-readable medium may also be implemented as a format of carrier wave (e.g., transmission via an Internet). The computer may include the controller of the terminal. Therefore, it should also be understood that the above-described embodiments are not limited by any of the details of the foregoing description, unless otherwise specified, but rather should be construed broadly within its scope as defined in the appended claims, Therefore, all changes and modifications that fall within the metes and bounds of the claims, or equivalents of such metes and bounds are therefore intended to be embraced by the appended claims.

1-23. (canceled)

24. An antenna assembly comprising:
a dielectric substrate;
a first region comprising conductive patterns on one side of the dielectric substrate and configured to radiate a wireless signal; and
a second region comprising a ground conductive pattern and a feed pattern,
wherein the conductive patterns comprise:
a first conductive pattern comprising a first portion and a second portion, wherein the first portion is substantially perpendicular to the second portion and the second portion is electrically connected to the feed pattern;
a second conductive pattern electrically connected to a first portion of the ground conductive pattern; and
a third conductive pattern electrically connected to a second portion of the ground conductive pattern,
wherein:
the second conductive pattern has a size smaller than a size of the third conductive pattern;
the second conductive pattern is located between the first portion of the first conductive pattern and the second portion of the first conductive pattern;
the first portion of the first conductive pattern is located opposite to the third conductive pattern with respect to the second portion of the first conductive pattern,
the first conductive pattern and the third conductive pattern are configured to operate in a dipole antenna mode in a first frequency band;
the first conductive pattern is configured to operate in a monopole antenna mode in a second frequency band; and
the second frequency band is higher than the first frequency band.

25. The antenna assembly of claim 24, wherein the first conductive pattern and the third conductive pattern each have an asymmetrical structure.

26. The antenna assembly of claim 25, wherein the second conductive pattern operates in a third frequency band, and
the third frequency band is higher than the second frequency band.

27. The antenna assembly of claim 24, wherein:
a first boundary side of the first portion of the first conductive pattern has a first stepped structure;
a second boundary side of the first portion of the first conductive pattern has a second stepped structure different from the first stepped structure;
a third boundary side of the first portion of the first conductive pattern is disposed between a first end of the first boundary side of the first portion of the first conductive pattern and a first end of the second boundary side of the first portion of the first conductive pattern;
a fourth boundary side of the first portion of the first conductive pattern is disposed between a second end of the first boundary side of the first portion of the first conductive pattern and a second end of the second boundary side of the first portion of the first conductive pattern;
a first boundary side of the third conductive pattern has a third step structure;
a second boundary side of the third conductive pattern has a linear structure;
a third boundary side of the third conductive pattern is disposed between a first end of the first boundary side of the third conductive pattern and a first end of the second boundary side of the third conductive pattern,
a fourth boundary side of the third conductive pattern is disposed between a second end of the first boundary side of the third conductive pattern and a second end of the second boundary side of the third conductive pattern, and
a length of the dielectric substrate along a first direction is equal to a length of the third boundary side of the third conductive pattern along the first direction and a length of the third boundary side of the first conductive pattern along the first direction.

28. The antenna assembly of claim 27, wherein a part of the first boundary side of the first portion of the first conductive pattern faces a first boundary side of the second conductive pattern, and
a part of the first boundary side of the second conductive pattern faces a second boundary side of the second conductive pattern.

29. The antenna assembly of claim 28, wherein: a second end of the first boundary side of the third conductive pattern is connected to the second portion of the ground conductive pattern,
the second boundary side of the third conductive pattern is disposed opposite to the first boundary side of the third conductive pattern, and
the second portion of the first conductive pattern faces the fourth boundary side of the third conductive pattern.

30. The antenna assembly of claim 24, wherein:
the second region further comprises a first slot;
a length of the first slot is in a range from 2/2 to 2; and
an open region of the first slot faces the feed pattern.

31. The antenna assembly of claim 24, wherein
the second region further comprises a second slot;
a length of the second slot is in a range from 2/2 to 2; and
an open region of the second slot faces the first region.

32. The antenna assembly of claim 24, wherein:
the first conductive pattern, the second conductive pattern, and the third conductive pattern are configured to have a metal mesh shape having a plurality of open regions on the dielectric substrate; and
the first conductive pattern, the second conductive pattern, and the third conductive pattern are configured to have a coplanar waveguide (CPW) structure on the dielectric substrate.

33. The antenna assembly of claim 24, comprising a plurality of dummy metal grid patterns at an outside portion of the first region on the dielectric substrate,
wherein the plurality of dummy metal grid patterns are not connected to the feed pattern and the ground conductive pattern, and
wherein the plurality of dummy metal grid patterns are separate from each other.
